(19) United States
(12) Patent Application Publication
(10) Pub. No.: US 2022/0198429 A1
(43) Pub. Date: Jun. 23, 2022

(54) METHOD FOR TRANSMITTING AND RECEIVING SIGNAL BY UE IN WIRELESS COMMUNICATION SYSTEM SUPPORTING SIDELINK AND DEVICE THEREFOR

(71) Applicant: LG Electronics Inc., Seoul (KR)

(72) Inventor: Seungryul YANG, Seoul (KR)

(21) Appl. No.: 17/429,187

(22) PCT Filed: Mar. 27, 2020
(86) PCT No.: PCT/KR2020/004251

§ 371 Date: Aug. 6, 2021

(30) Foreign Application Priority Data
Mar. 27, 2019 (KR) 10-2019-0035235

(51) Int. Cl. G06Q 20/30; G06Q 20/14; G06Q 20/32

(52) U.S. Cl. CPC G06Q 20/308; G06Q 20/3255; G06Q 20/327; G06Q 20/14

(57) ABSTRACT

According to various embodiments, a method for receiving a signal by user equipment (UE) in a wireless communication system supporting sidelink and a device therefor are disclosed. The method for receiving a signal by UE, and the device therefor are disclosed, the method comprising the steps of: receiving, from a road side unit (RSU) through the sidelink, a first message including information associated with electronic payment; transmitting corresponding payment information to a second device on the basis of an invoice type included in the first message; and receiving payment means information from the second device through an additionally configured first communication link, wherein the first communication link is a communication link formed on the basis of a near field communication technology.

### TECHNICAL FIELD

The present disclosure relates to a method for transmitting and receiving a signal by a UE in a wireless communication system supporting a sidelink and a device therefore, and more particularly, to a method for transmitting and receiving a signal for an electronic payment based on V2X communication and a device therefor.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (B SM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### SUMMARY

An object of the present disclosure devised to solve the problem is to provide a convenient and efficient electronic payment method for users through an electronic payment system that is based on a V2X communication link, and to provide a safe electronic payment method by minimizing the leakage of payment method information to the outside by introducing a virtual receiving device and a short-distance communication link.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

In one aspect of the present disclosure, a method for transmitting and receiving an electronic payment related signal by a user equipment (UE) in a wireless communication system supporting a sidelink, the method may include receiving a first message containing information related to electronic payment from a roadside unit (RSU) through the sidelink, transmitting corresponding payment information to a second device based on an invoice type included in the first message, and receiving payment method information from the second device through a first communication link configured separately, wherein the first communication link may be a communication link created based on a short-range communication technology.

Alternatively, the short-range communication technology may be for short-range communication according to at least one of a magnetic stripe, an IC chip, near-field communication (NFC), a bar code, and a radio-frequency identification (RFID) tag.

Alternatively, the invoice type may include a first type containing predetermined payment information, and a second type in which payment information is differently determined according to a response of the first device or a type of a vehicle including the first device.

Alternatively, when the invoice type is the second type, the first message is a response message to periodic transmission of at least one of a cooperative awareness message (CAM), a decentralized environmental notification message (DENM), or a basic safety message (B SM) of the first device.

Alternatively, the method may further include when the invoice type is the second type, transmitting to the RSU a second message containing item information on an item necessary for determination of a payment amount, wherein the payment information may be acquired based on a payment request message, the payment request message being a response message to the second message.

Alternatively, the first message further contains allocation information about time slots for transmission of a message of the RSU, wherein a transmission timing of the second message may be determined based on the allocation information.

Alternatively, the allocation information includes the number of RSUs included in a preconfigured region, time resource allocation information about each of the RSUs, and information about a transmission period.

Alternatively, a transmission timing of the second message is determined based on a degree of phase shift acquired based on a positioning reference signal (PRS) or a phase tracking reference signal (PTRS) included in the first message.

Alternatively, when the invoice type is a first type, the first message is periodically and repeatedly transmitted by the RSU regardless of whether the first device approaches.

Alternatively, the method may further include transmitting the payment method information to a payment server, and receiving information on a payment result from the payment server, wherein the payment method information may be transmitted according to a security protocol configured by the payment server.

Alternatively, the first device may be attached to the same ITS-S or vehicle as the second device.

In another aspect of the present disclosure, a first device for transmitting and receiving a signal in a wireless communication system supporting a sidelink may include a radio frequency (RF) transceiver, and a processor connected to the RF transceiver. The processor may control the RF transceiver to receive a first message containing information related to electronic payment from a roadside unit (RSU) through the sidelink, transmit corresponding payment information to a second device based on an invoice type included in the first message, and receive payment method information from the second device through a first communication link configured separately, wherein the first communication link may be a communication link created based on a short-range communication technology.

Alternatively, the short-range communication technology may be for short-range communication according to at least one of a magnetic stripe, an IC chip, near-field communication (NFC), a bar code, and a radio-frequency identification (RFID) tag.

In another aspect of the present disclosure, a chipset for transmitting and receiving signals in a wireless communication system supporting a sidelink may include at least one processor, and at least one memory operatively connected to the at least one processor and, when executed, causing the at least one processor to perform an operation. The operation may include receiving a first message containing information related to electronic payment from a roadside unit (RSU) through the sidelink, transmitting corresponding payment information to a second device based on an invoice type included in the first message, and receiving payment method information from the second device through a first communication link configured separately, wherein the first communication link may be a communication link created based on a short-range communication technology.

Alternatively, the processor may control a driving mode of a device connected to the chipset based on the invoice type.

Various embodiments may provide a convenient and efficient electronic payment method for users through an electronic payment system that is based on a V2X communication link. In addition, by minimizing the leakage of payment method information to the outside by introducing a virtual receiving device and a short-distance communication link, electronic payments with improved security and stability may be performed.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates a user-plane radio protocol architecture to which embodiment(s) are applicable.

FIG. 4 illustrates a control-plane radio protocol architecture to which embodiment(s) are applicable.

FIG. 5 illustrates the structure of an NR system to which embodiment(s) are applicable.

FIG. 6 illustrates functional split between an NG-RAN and a 5GC to which embodiment(s) are applicable.

FIG. 7 illustrates the structure of an NR radio frame to which embodiment(s) are applicable.

FIG. 8 illustrates the slot structure of an NR frame to which embodiment(s) are applicable.

FIG. 9 illustrates a radio protocol architecture for SL communication.

FIG. 10 shows the structures of an S-SSB according to CP types.

FIG. 11 illustrates UEs performing V2X or SL communication.

FIG. 12 illustrates resource units for V2X or SL communication.

FIG. 13 illustrates a procedure in which UEs perform V2X or SL communication according to a transmission mode.

FIG. 14 illustrates a V2X synchronization source or synchronization reference to which embodiments(s) are applicable.

FIG. 15 is a diagram illustrating a method for performing electronic payment related to V2X.

FIG. 16 is a diagram illustrating a method for performing electronic payment related to V2X through a virtual payee.

FIG. 17 is a diagram illustrating a method for recognizing a payer or a virtual payee which is to perform electronic payment.

FIGS. 18 and 19 are diagrams illustrating a method for recognizing or detecting a target to perform V2X-based electronic payment.

FIGS. 20 and 21 are diagrams illustrating a period and time resources in which the payee transmits an indication message.

FIGS. 22 and 23 are diagrams illustrating an electronic payment method for invoice A.

FIGS. 24 and 25 are diagrams illustrating an electronic payment method based on invoice B.

FIGS. 26 and 27 are diagrams illustrating a method for a virtual payee to perform an electronic payment based on V2X communication.

FIG. 28 illustrates a communication system applied to the present invention;

FIG. 29 illustrates wireless devices applicable to the present invention.

FIG. 30 illustrates another example of a wireless device to which the present invention is applied. The wireless device may be implemented in various forms according to use-examples/services.

FIG. 31 illustrates a hand-held device applied to the present invention;

FIG. 32 illustrates a vehicle or an autonomous driving vehicle applied to the present invention.

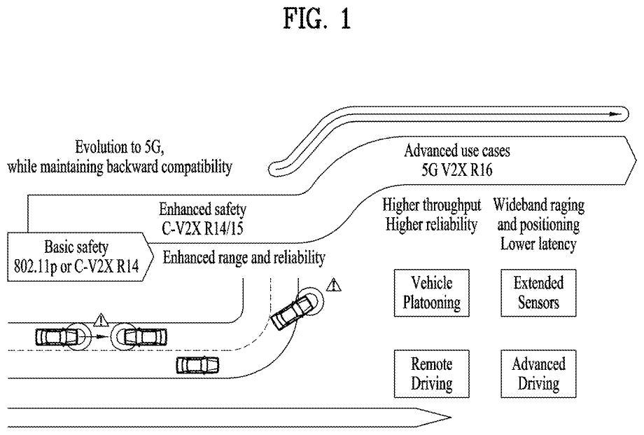

### DETAILED DESCRIPTION

The wireless communication system is a multiple access system that supports communication with multiple users by sharing available system resources (eg, bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

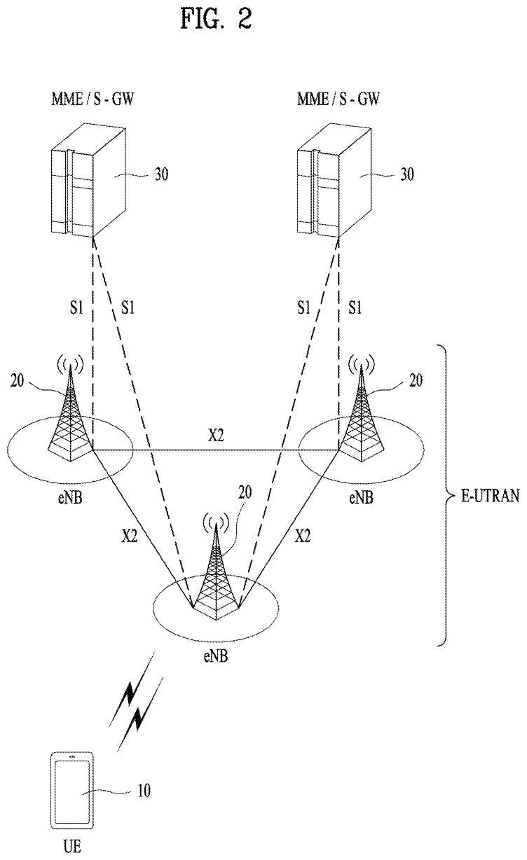

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

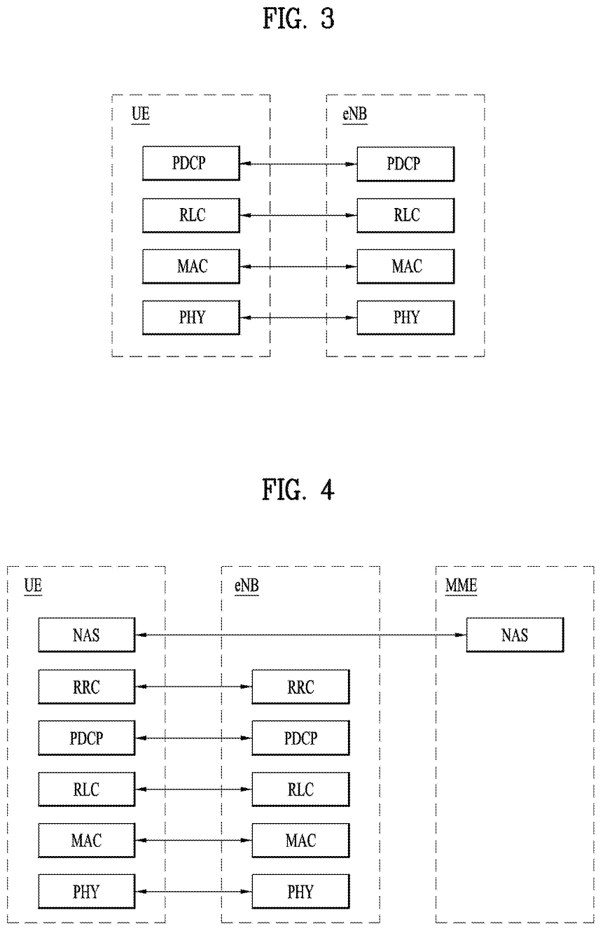

FIG. 3 illustrates a user-plane radio protocol architecture to which the present disclosure is applicable.

FIG. 4 illustrates a control-plane radio protocol architecture to which the present disclosure is applicable. A user plane is a protocol stack for user data transmission, and a control plane is a protocol stack for control signal transmission.

Referring to FIGS. 3 and 4, the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QoS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbols in the time domain by a plurality of subcarriers in the frequency domain. One subframe includes a plurality of OFDM symbols in the time domain. An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

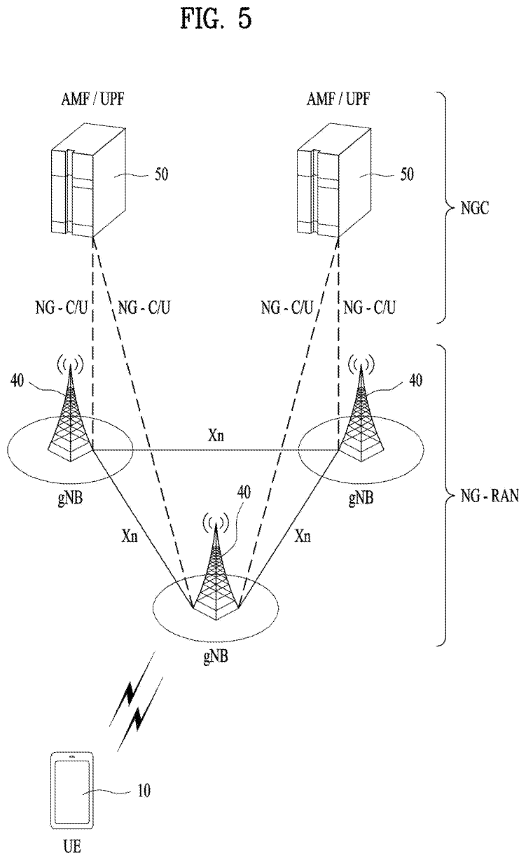

FIG. 5 illustrates the structure of a NR system to which the present disclosure is applicable.

Referring to FIG. 5, a next generation radio access network (NG-RAN) may include a next generation Node B (gNB) and/or an eNB, which provides user-plane and control-plane protocol termination to a UE. In FIG. 5, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

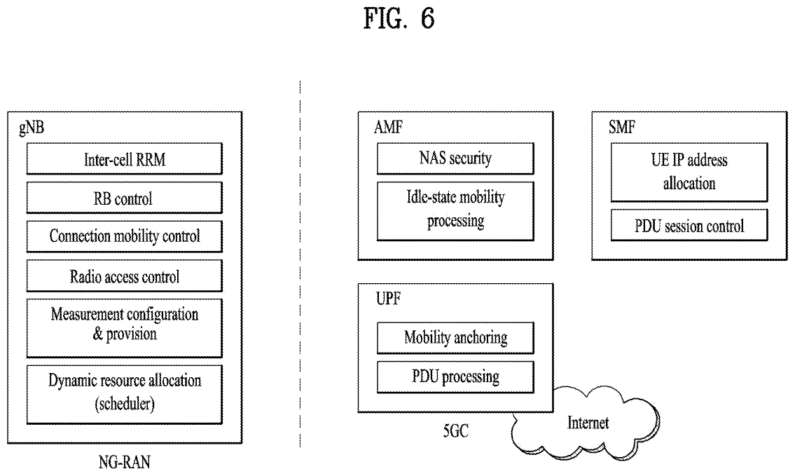

FIG. 6 illustrates functional split between the NG-RAN and the 5GC to which the present disclosure is applicable.

Referring to FIG. 6, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

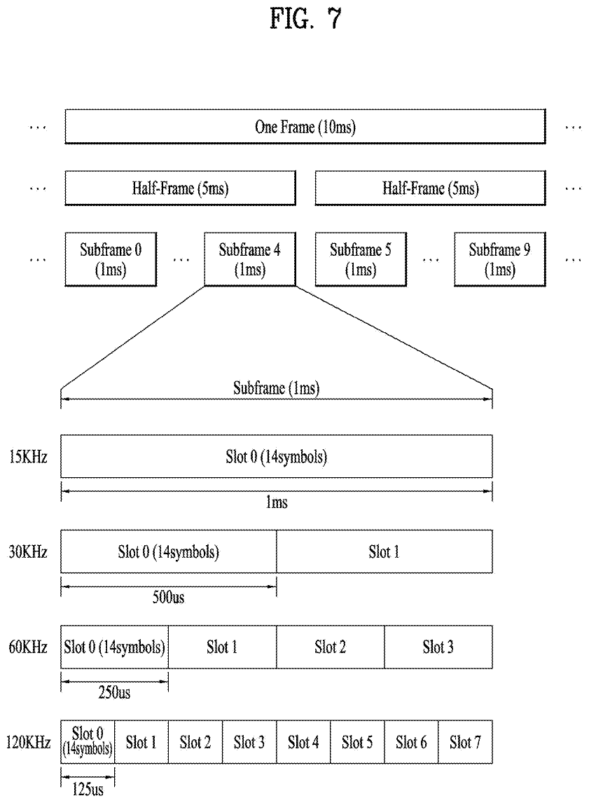

FIG. 7 illustrates the structure of a NR radio frame to which the present disclosure is applicable.

Referring to FIG. 7, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame}ₛₗₒₜ, and the number of slots per subframe N^{subframe,u}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier | |
|---|---|---|---|
| designation | frequency range | Spacing (SCS) | |
| FR1 | 450 MHz-6000 MHz | 15, 30, 60 | kHz |
| FR2 | 24250 MHz-52600 MHz | 60, 120, 240 | kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier | |
|---|---|---|---|
| designation | frequency range | Spacing (SCS) | |
| FR1 | 410 MHz-7125 MHz | 15, 30, 60 | kHz |
| FR2 | 24250 MHz-52600 MHz | 60, 120, 240 | kHz |

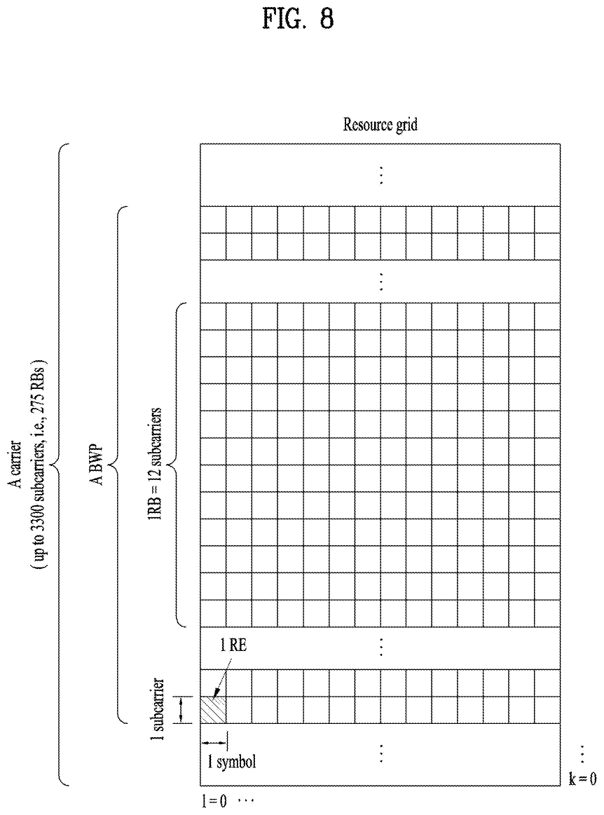

FIG. 8 illustrates the slot structure of a NR frame to which the present disclosure is applicable.

Referring to FIG. 8, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

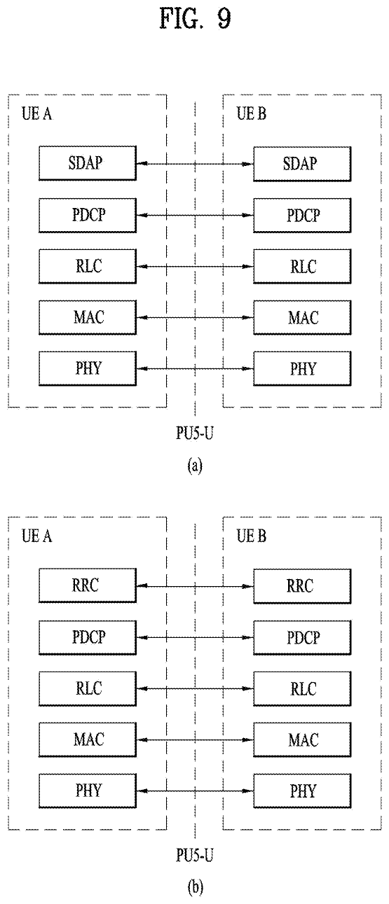

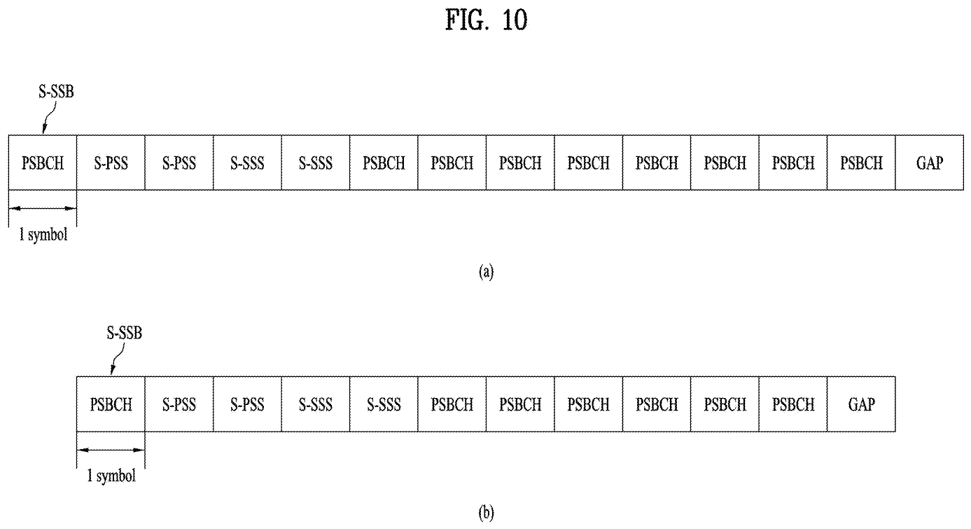

FIG. 9 illustrates a radio protocol architecture for SL communication. Specifically, FIG. 9-(a) shows a user plane protocol stack of NR, and FIG. 9-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre)set sidelink BWP (SL BWP). For example, the bandwidth of the S-SSB may be 11 resource blocks (RBs). For example, the PSBCH may span 11 RBs. The frequency position of the S-SSB may be (pre)set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

FIG. 10 illustrates the structures of an S-SSB according to CP types. FIG. 10-(a) shows the structure of the S-SSB when the CP type is NCP.

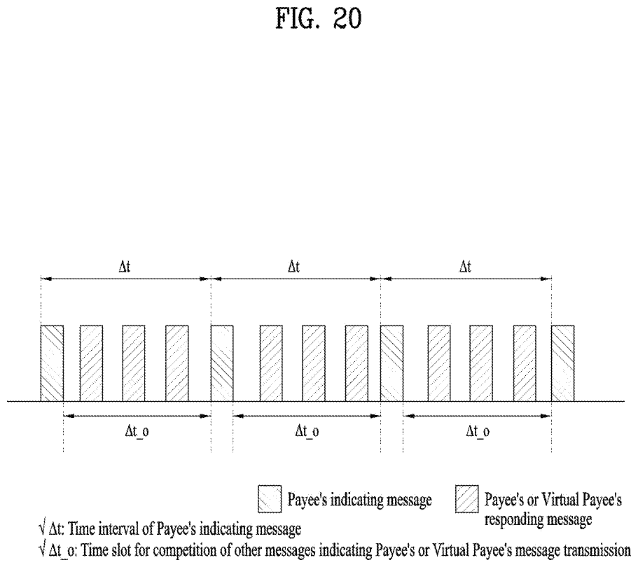

For example, the structure of the S-SSB, that is, the order of symbols to which the S-PSS, S-SSS, and PSBCH are mapped in the S-SSB transmitted by the transmitting UE when the CP type is NCP may be shown in FIG. 20.

FIG. 10-(b) shows the structure of the S-SSB when the CP type is ECP.

For example, when the CP type is ECP, the number of symbols to which the transmitting UE maps the PSBCH after the S-SSS in the S-SSB may be 6, unlike in FIG. 20. Accordingly, the coverage of the S-SSB may differ between the CP types, NCP and ECP.

Each SLSS may have an SL synchronization identifier (SLSS ID).

For example, in the case of LTE SL or LTE V2X, the value of the SLSS ID may be defined based on a combination of two different S-PSS sequences and 168 different S-SSS sequences. For example, the number of SLSS IDs may be 336. For example, the value of the SLSS ID may be any one of 0 to 335.

For example, in the case of NR SL or NR V2X, the value of the SLSS ID may be defined based on a combination of two different S-PSS sequences and 336 different S-SSS sequences. For example, the number of SLSS IDs may be 672. For example, the value of the SLSS ID may be any one of 0 to 671. For example, one S-PSS of the two different S-PSSs may be associated with in-coverage, and the other S-PSS may be associated with out-of-coverage. For example, SLSS IDs of 0 to 335 may be used in in-coverage, and SLSS IDs of 336 to 671 may be used in out-of-coverage.

In order to improve the S-SSB reception performance of the receiving UE, the transmitting UE needs to optimize the transmit power according to the characteristics of respective signals constituting the S-SSB. For example, according to the peak to average power ratio (PAPR) of each signal constituting the S-SSB, the transmitting UE may determine the value of maximum power reduction (MPR) for each signal. For example, when the PAPR differs between the S-PSS and the S-SSS which constitute the S-SSB, the transmitting UE may apply an optimal MPR value to transmission of each of the S-PSS and the S-SSS in order to improve the S-SSB reception performance of the receiving UE. Also, for example, in order for the transmitting UE to perform an amplification operation on each signal, a transition period may be applied. The transition period may reserve a time required for the transmitter amplifier of the transmitting UE to perform a normal operation at the boundary where the transmit power of the transmitting UE varies. For example, in the case of FR1, the transition period may be 10 μs. For example, in the case of FR2, the transition period may be 5 μs. For example, a search window in which the receiving UE is to detect the S-PSS may be 80 ms and/or 160 ms.

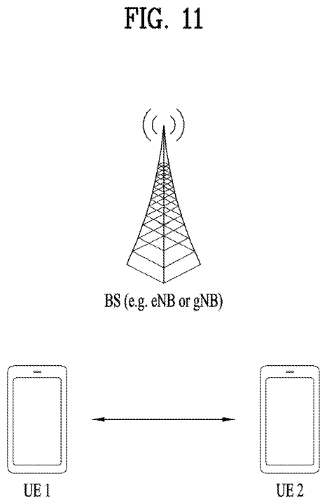

FIG. 11 illustrates UEs performing V2X or SL communication.

Referring to FIG. 11, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

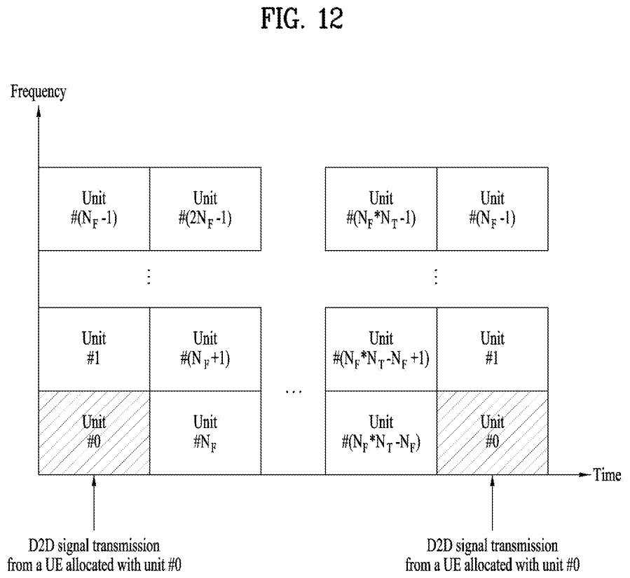

FIG. 12 illustrates resource units for V2X or SL communication.

Referring to FIG. 12, the frequency resources of a resource pool may be divided into NF sets, and the time resources of the resource pool may be divided into NT sets. Accordingly, a total of NF*NT resource units may be defined in the resource pool. FIG. 12 shows an exemplary case where the resource pool is repeated with a periodicity of NT subframes.

As shown in FIG. 12, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

Hereinafter, resource allocation in the SL will be described.

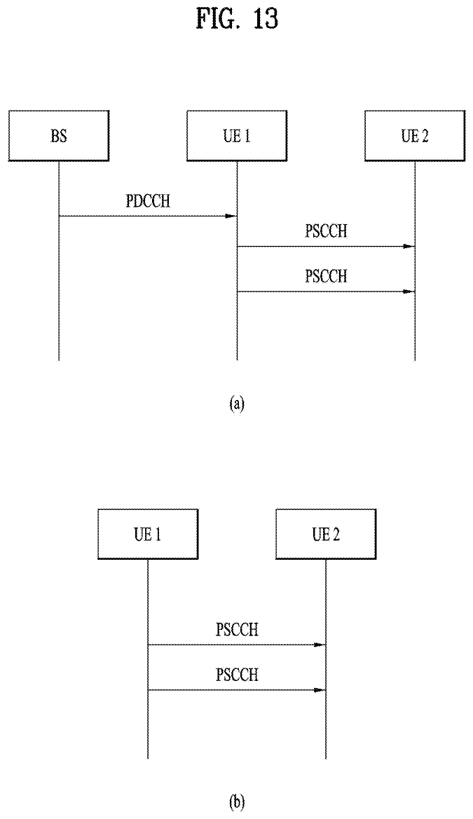

FIG. 13 illustrates a procedure in which UEs perform V2X or SL communication according to a transmission mode. In various embodiments of the present disclosure, the transmission mode may be referred to as a mode or a resource allocation mode. Hereinafter, for simplicity, the transmission mode in LTE may be referred to as an LTE transmission mode, and the transmission mode in NR may be referred to as an NR resource allocation mode.

For example, FIG. 13-(a) illustrates a UE operation related to LTE transmission mode 1 or LTE transmission mode 3. Alternatively, for example, FIG. 13-(a) illustrates a UE operation related to NR resource allocation mode 1. For example, LTE transmission mode 1 may be applied to general SL communication, and LTE transmission mode 3 may be applied to V2X communication.

For example, FIG. 13-(b) illustrates a UE operation related to LTE transmission mode 2 or LTE transmission mode 4. Alternatively, for example, FIG. 13-(b) illustrates a UE operation related to NR resource allocation mode 2.

Referring to FIG. 13-(a), in LTE transmission mode 1, LTE transmission mode 3 or NR resource allocation mode 1, the BS may schedule an SL resource to be used by the UE for SL transmission. For example, the BS may perform resource scheduling for UE 1 through PDCCH (more specifically, downlink control information (DCI)), and UE 1 may perform V2X or SL communication with UE 2 according to the resource scheduling. For example, UE 1 may transmit sidelink control information (SCI) to UE 2 on a physical sidelink control channel (PSCCH), and then transmit data which is based on the SCI to UE 2 on a physical sidelink shared channel (PSSCH).

For example, in NR resource allocation mode 1, the UE may be provided with or allocated resources for one or more SL transmissions of a transport block (TB) from the BS through a dynamic grant. For example, the BS may provide a resource for transmission of the PSCCH and/or PSSCH to the UE using the dynamic grant. For example, the transmitting UE may report the SL hybrid automatic repeat request (HARQ) feedback received from the receiving UE to the BS. In this case, the PUCCH resource and timing for reporting the SL HARQ feedback to the BS may be determined based on an indication in the PDCCH through the BS is to allocate a resource for SL transmission.

For example, DCI may include a slot offset between DCI reception and the first SL transmission scheduled by the DCI. For example, the minimum gap between the DCI scheduling a SL transmission resource and the first scheduled SL transmission resource may not be shorter than the processing time of the corresponding UE.

For example, in NR resource allocation mode 1, the UE may be periodically provided with or allocated a resource set from the BS for a plurality of SL transmissions through a configured grant. For example, the configured grant may include configured grant type 1 or configured grant type 2. For example, the UE may determine a TB to be transmitted in each occasion indicated by a given configured grant.

For example, the BS may allocate SL resources to the UE on the same carrier, and may allocate SL resources to the UE on different carriers.

For example, an NR BS may control LTE-based SL communication. For example, the NR BS may transmit NR DCI to the UE to schedule an LTE SL resource. In this case, for example, a new RNTI for scrambling the NR DCI may be defined. For example, the UE may include an NR SL module and an LTE SL module.

For example, after the UE including the NR SL module and the LTE SL module receives NR SL DCI from the gNB, the NR SL module may transform the NR SL DCI to LTE DCI type 5A, and the NR SL module may deliver LTE DCI type 5A to the LTE SL module in units of X ms. For example, the LTE SL module may apply activation and/or release to the first LTE subframe Z ms after the LTE SL module receives LTE DCI format 5A from the NR SL module. For example, the X may be dynamically indicated using a field of DCI. For example, the minimum value of X may depend on the UE capability. For example, the UE may report a single value according to the UE capability. For example, X may be a positive number.

Referring to FIG. 13-(b), in LTE transmission mode 2, LTE transmission mode 4, or NR resource allocation mode 2, the UE may determine AN SL resource within the SL resources configured by the BS/network or the preconfigured SL resources. For example, the configured SL resources or the preconfigured SL resources may be a resource pool. For example, the UE may autonomously select or schedule a resource for SL transmission. For example, the UE may autonomously select a resource within the configured resource pool to perform SL communication. For example, the UE may select a resource within a selection window by performing a sensing and resource (re)selection procedure. For example, the sensing may be performed on a per sub-channel basis. In addition, UE 1, which has selected a resource within the resource pool, may transmit SCI to UE 2 through the PSCCH, and then transmit data, which is based on the SCI, to UE 2 through the PSSCH.

For example, a UE may assist in selecting an SL resource for another UE. For example, in NR resource allocation mode 2, the UE may receive a configured grant for SL transmission. For example, in NR resource allocation mode 2, the UE may schedule SL transmission of another UE. For example, in NR resource allocation mode 2, the UE may reserve an SL resource for blind retransmission.

For example, in NR resource allocation mode 2, UE 1 may indicate the priority of SL transmission to UE 2 using the SCI. For example, UE 2 may decode the SCI. UE 2 may perform sensing and/or resource (re)selection based on the priority. For example, the resource (re)selection procedure may include an operation of identifying candidate resources in a resource selection window by UE 2, and an operation of selecting, by UE 2, a resource for (re)transmission from among the identified candidate resources. For example, the resource selection window may be a time interval during which the UE selects the resource for SL transmission. For example, after UE 2 triggers resource (re)selection, the resource selection window may start at T1≥0. The resource selection window may be limited by the remaining packet delay budget of UE 2. For example, in the operation of identifying the candidate resources in the resource selection window by UE 2, a specific resource may be indicated by the SCI received by UE 2 from UE 1. When the L1 SL RSRP measurement value for the specific resource exceeds an SL RSRP threshold, UE 2 may not determine the specific resource as a candidate resource. For example, the SL RSRP threshold may be determined based on the priority of the SL transmission indicated by the SCI received by UE 2 from UE 1 and the priority of the SL transmission on the resource selected by UE 2.

For example, the L1 SL RSRP may be measured based on an SL demodulation reference signal (DMRS). For example, one or more PSSCH DMRS patterns may be configured or preconfigured for each resource pool in the time domain. For example, PDSCH DMRS configuration type 1 and/or type 2 may be the same as or similar to the frequency domain pattern of the PSSCH DMRS. For example, the exact DMRS pattern may be indicated by the SCI. For example, in NR resource allocation mode 2, the transmitting UE may select a specific DMRS pattern from among DMRS patterns configured or preconfigured for the resource pool.

For example, in NR resource allocation mode 2, based on the sensing and resource (re)selection procedure, the transmitting UE may perform initial transmission of a TB without reservation. For example, based on the sensing and resource (re)selection procedure, using the SCI associated with a first TB, the transmitting UE may reserve the SL resource for initial transmission of a second TB.

For example, in NR resource allocation mode 2, the UE may reserve a resource for feedback-based PSSCH retransmission through signaling related to previous transmission of the same TB. For example, the maximum number of SL resources reserved by one transmission including the current transmission may be 2, 3, or 4. For example, the maximum number of SL resources may be the same regardless of whether HARQ feedback is enabled. For example, the maximum number of HARQ (re)transmissions for one TB may be limited by configuration or pre-configuration. For example, the maximum number of HARQ (re)transmissions may be up to 32. For example, when the configuration or pre-configuration is not present, the maximum number of HARQ (re)transmissions may be unspecified. For example, the configuration or pre-configuration may be for the transmitting UE. For example, in NR resource allocation mode 2, HARQ feedback for releasing resources not used by the UE may be supported.

For example, in NR resource allocation mode 2, the UE may indicate to another UE one or more sub-channels and/or slots used by the UE, using the SCI. For example, the UE may indicate to another UE one or more sub-channels and/or slots reserved by the UE for PSSCH (re)transmission, using SCI. For example, the minimum allocation unit of the SL resource may be a slot. For example, the size of the sub-channel may be configured for the UE or may be preconfigured.

Hereinafter, sidelink control information (SCI) will be described.

Control information transmitted by the BS to the UE on the PDCCH may be referred to as downlink control information (DCI), whereas control information transmitted by the UE to another UE on the PSCCH may be referred to as SCI. For example, before decoding the PSCCH, the UE may be aware of the start symbol of the PSCCH and/or the number of symbols of the PSCCH. For example, the SCI may include SL scheduling information. For example, the UE may transmit at least one SCI to another UE to schedule the PSSCH. For example, one or more SCI formats may be defined.

For example, the transmitting UE may transmit the SCI to the receiving UE on the PSCCH. The receiving UE may decode one SCI to receive the PSSCH from the transmitting UE.

For example, the transmitting UE may transmit two consecutive SCIs (e.g., 2-stage SCI) to the receiving UE on the PSCCH and/or the PSSCH. The receiving UE may decode the two consecutive SCIs (e.g., 2-stage SCI) to receive the PSSCH from the transmitting UE. For example, when the SCI configuration fields are divided into two groups in consideration of the (relatively) high SCI payload size, the SCI including a first SCI configuration field group may be referred to as first SCI or 1st SCI, and the SCI including a second SCI configuration field group may be referred to as second SCI or 2nd SCI. For example, the transmitting UE may transmit the first SCI to the receiving UE on the PSCCH. For example, the transmitting UE may transmit the second SCI to the receiving UE on the PSCCH and/or the PSSCH. For example, the second SCI may be transmitted to the receiving UE on the (independent) PSCCH, or may be piggybacked together with data and transmitted on the PSSCH. For example, the two consecutive SCIs may be applied for different transmissions (e.g., unicast, broadcast, or groupcast).

For example, the transmitting UE may transmit some or all of the following information to the receiving UE through SCI. Here, for example, the transmitting UE may transmit some or all of the following information to the receiving UE through the first SCI and/or the second SCI:

PSSCH and/or PSCCH related resource allocation information, for example, the positions/number of time/frequency resources, resource reservation information (e.g., periodicity); and/or

SL CSI report request indicator or SL (L1) RSRP (and/or SL (L1) RSRQ and/or SL (L1) RSSI) report request indicator; and/or

SL CSI transmission indicator (or SL (L1) RSRP (and/or SL (L1) RSRQ and/or SL (L1) RSSI) information transmission indicator) (on PSSCH); and/or

MCS information; and/or

transmit power information; and/or

L1 destination ID information and/or L1 source ID information; and/or

SL HARQ process ID information; and/or

new data indicator (NDI) information; and/or

redundancy version (RV) information; and/or

(transmission traffic/packet related) QoS information; e.g., priority information; and/or

SL CSI-RS transmission indicator or information on the number of (transmitted) SL CSI-RS antenna ports;

Location information about the transmitting UE or location (or distance/area) information about a target receiving UE (to which a request for SL HARQ feedback is made); and/or

information about a reference signal (e.g., DMRS, etc.) related to decoding and/or channel estimation of data transmitted on the PSSCH, for example, information related to a pattern of a (time-frequency) mapping resource of DMRS, rank information, antenna port index information.

For example, the first SCI may include information related to channel sensing. For example, the receiving UE may decode the second SCI using the PSSCH DMRS. A polar code used for the PDCCH may be applied to the second SCI. For example, in the resource pool, the payload size of the first SCI may be the same for unicast, groupcast and broadcast. After decoding the first SCI, the receiving UE does not need to perform blind decoding of the second SCI. For example, the first SCI may include scheduling information about the second SCI.

In various embodiments of the present disclosure, since the transmitting UE may transmit at least one of SCI, the first SCI, and/or the second SCI to the receiving UE on the PSCCH, the PSCCH may be replaced/substituted with at least one of the SCI, the first SCI, and/or the second SCI. Additionally/alternatively, for example, the SCI may be replaced/substituted with at least one of the PSCCH, the first SCI, and/or the second SCI. Additionally/alternatively, for example, since the transmitting UE may transmit the second SCI to the receiving UE on the PSSCH, the PSSCH may be replaced/substituted with the second SCI.

Hereinafter, synchronization acquisition by an SL UE will be described.

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

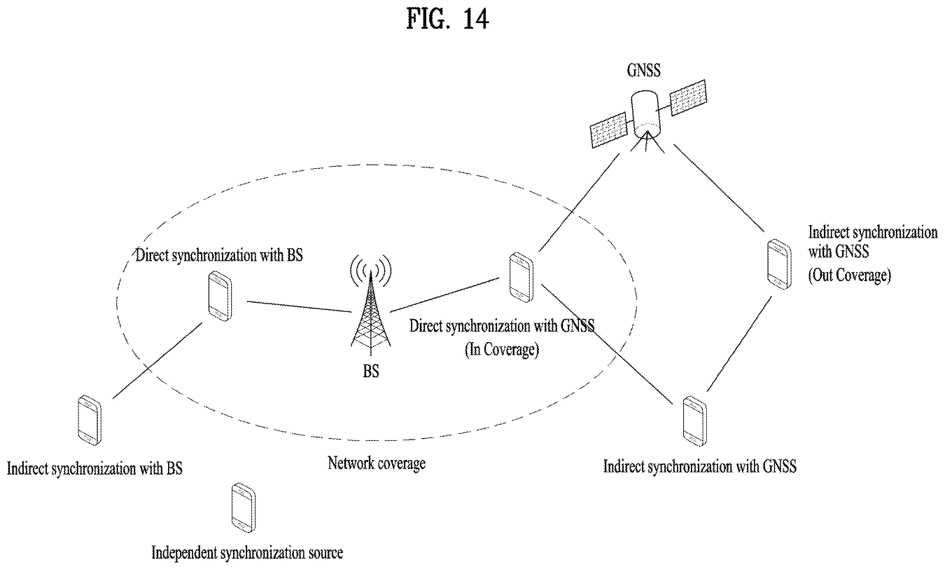

FIG. 14 illustrates a V2X synchronization source or reference to which the present disclosure is applicable.

Referring to FIG. 14, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or sidelink communication. In this case, the UE may follow the synchronization configuration received from the BS. When the UE fails in detecting any cell in the carrier used for the V2X or sidelink communication and receiving the synchronization configuration from the serving cell, the UE may follow a predetermined synchronization configuration.

Alternatively, the UE may be synchronized with another UE which has not acquired synchronization information directly or indirectly from the BS or GNSS. A synchronization source and a preference may be preset for the UE. Alternatively, the synchronization source and the preference may be configured for the UE by a control message provided by the BS.

A sidelink synchronization source may be related to a synchronization priority. For example, the relationship between synchronization sources and synchronization priorities may be defined as shown in Tables 5 and 6. Tables 5 and 6 are merely an example, and the relationship between synchronization sources and synchronization priorities may be defined in various manners.

TABLE 5

| | | BS-based synchronization |
|---|---|---|
| | | (eNB/gNB-based |
| Priority | GNSS-based synchronization | synchronization) |
| P0 | GNSS | BS |
| P1 | All UEs directly | All UEs directly synchronized |
| | synchronized with GNSS | with BS |
| P2 | All UEs indirectly | All UEs indirectly synchronized |
| | synchronized with GNSS | with BS |
| P3 | All other UEs | GNSS |
| P4 | N/A | All UEs directly synchronized |
| | | with GNSS |
| P5 | N/A | All UEs indirectly synchronized |
| | | with GNSS |
| P6 | N/A | All other UEs |

TABLE 6

| | GNSS-based | eNB/gNB-based |
|---|---|---|
| Priority | synchronization | synchronization |
| P0 | GNSS | BS |
| P1 | All UEs directly | All UEs directly |
| | synchronized with GNSS | synchronized with BS |
| P2 | All UEs indirectly | All UEs indirectly |
| | synchronized with GNSS | synchronized with BS |
| P3 | BS | GNSS |
| P4 | All UEs directly | All UEs directly |
| | synchronized with BS | synchronized with GNSS |
| P5 | All UEs indirectly | All UEs indirectly |
| | synchronized with BS | synchronized with GNSS |
| P6 | Remaining UE(s) with | Remaining UE(s) with |
| | lowpriority | low priority |

In Table 5 or Table 6, PO may denote the highest priority, and P6 may denote the lowest priority. In Table 5 or Table 6, the BS may include at least one of a gNB or an eNB.

Whether to use GNSS-based synchronization or BS-based synchronization may be (pre)determined. In a single-carrier operation, the UE may derive its transmission timing from an available synchronization reference with the highest priority.

V2X Apparatus and Roles for Generic Electronic Payment

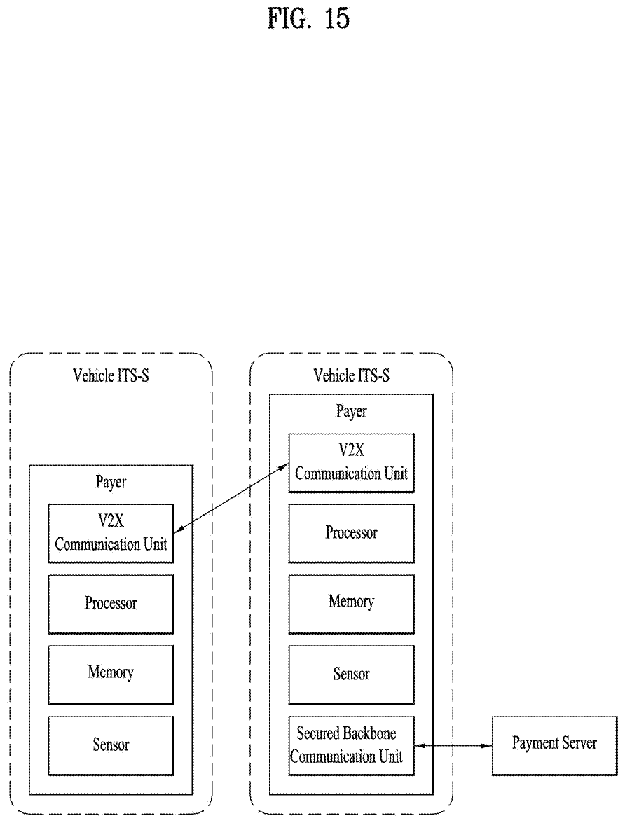

FIG. 15 is a diagram illustrating a method for performing electronic payment related to V2X.

Referring to FIG. 15, the electronic payment related to V2X may include a payer, a payee, and a payment server.

The payer may provide financial value for the payment by exchanging necessary information with the payee. The payer communicates with the payee using V2X technology. As shown in FIG. 15, the payer may be attached to or included in a vehicle ITS-S, and may be electrically connected (or mounted) to any type of ITS-S other than the vehicle.

The payee may acquire information necessary for payment from the payer, provide information necessary for the payer and the payee to the payment server, and optionally deliver or transmit the payment result acquired from the payment server to the payer. Here, the payee communicates with the payer using V2X technology. As shown in FIG. 15, the payee may be generally electrically connected (or mounted) to a roadside ITS-S, and may be electrically connected or mounted to any type of ITS-S other than the roadside ITS-S.

The payment server may proceed with payment based on the payment information acquired from the payee, and may transmit or deliver the payment result (e.g., payment rejected, payment completed, etc.) to the payee. The payment server may be a server for a network service provider, an Internet service provider, a mobile service provider, a bank, a financial company, or the like. Alternatively, the payment server may communicate with the payee using a dedicated network that is not directly related to V2X.

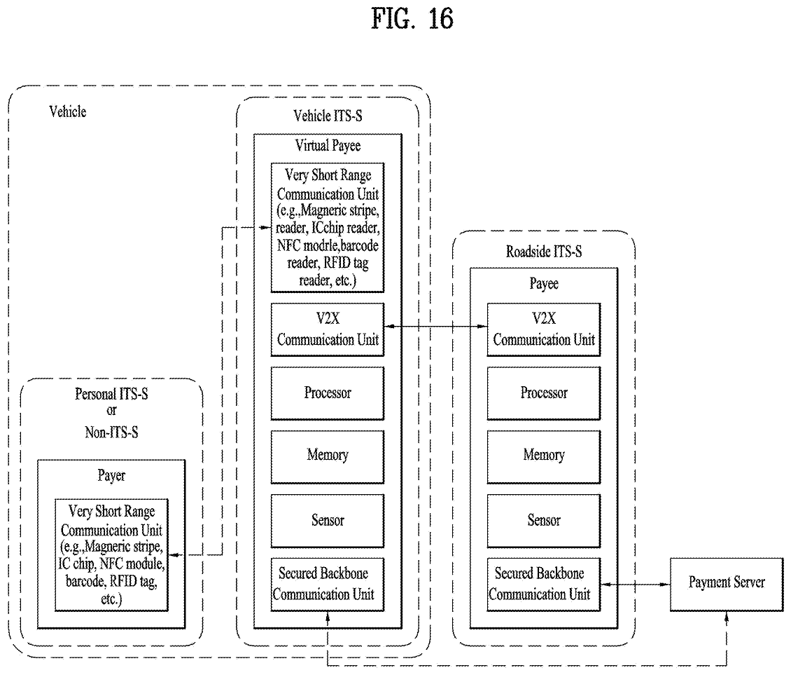

FIG. 16 is a diagram illustrating a method for performing electronic payment related to V2X through a virtual payee.

Referring to FIG. 16, the payment system may further include a virtual payee. In this case, the payer may provide information on a financial value related to payment by exchanging necessary information with the virtual payee. The payer may be electrically connected to the vehicle and may communicate with the virtual payee using a communication technology providing a relatively short communication range, such as magnetic stripe, IC chip, near-field communication (NFC), barcode, or radio-frequency identification (RFID) tag. In other words, the virtual payee and the payer may communicate with each other only through the short-range communication (communication within a few meters) such that the payment-related information is not received from an external device of the vehicle ITS-S in which the virtual payee and the payer are included. The payer may be a commonly used credit card (or debit card) or may be electrically connected to a mobile device or personal ITS-S. In addition, the payer may be electrically connected to any type of ITS-S.

The virtual payee may acquire necessary information related to payment from the payer and the payee, and provide information about the payer, the payee, and/or the virtual payee to the payment server. The virtual payee may provide information about a result of payment received from the payment server according to completion of the payment to the payer. The virtual payee may be electrically connected to the vehicle and may communicate with the payer (or the payee) using a communication technology for a relatively short communication range, such as magnetic stripe, IC chip, near-field communication (NFC), barcode, or radio-frequency identification (RFID) tag. The virtual payee may be electrically connected to a vehicle ITS-S, or may be electrically connected to various types of ITS-S. Alternatively, the virtual payee may communicate with the payment server using a secure network, which is a dedicated communication network and is configured to communicate with the payment server.

The payee may use V2X technology to provide the virtual payee with information necessary for payment. The payee may be generally electrically connected or mounted to a roadside ITS-S, but may not be limited thereto. It may be electrically connected to any type of ITS-S. In addition, the payee may communicate with the payment server using a secure network.

The payment server may receive information necessary for payment or settlement from the virtual payee and/or the payee to perform payment, and may transmit the payment result or settlement result to the virtual payee and/or the payer. The payment server may be a server of a network service provider, an Internet service provider, a mobile service provider, a bank, a financial company, or the like. The payment server may communicate with the virtual payee and/or the payee over a dedicated cellular communication network or the like using a secure network.

Hereinafter, electronic payment methods that may secure higher stability through V2X communication will be described.

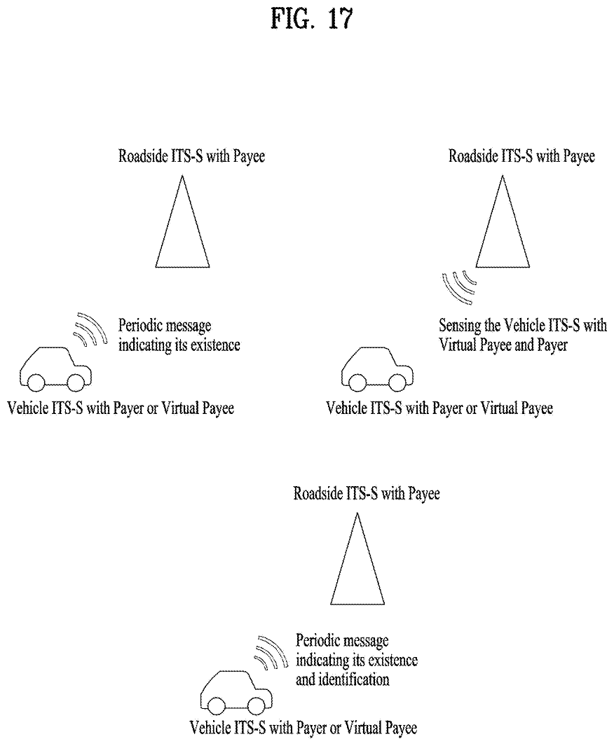

FIG. 17 is a diagram illustrating a method for recognizing a payer or a virtual payee which is to perform electronic payment.

An electronic payment method related to V2X may include a recognition step of recognizing or detecting a target that is to perform an electronic payment. The recognition step may be a step performed for the first time in the electronic payment method, or a step that is optionally performed. The recognition step may be divided into “a method in which only detection or recognition is performed” and “a method in which detection and identification are performed.”

Referring to FIG. 17, in the method in which only detection or recognition is performed, the payee detects or recognizes an approach of a payer, a virtual payee, or an ITS-S (including the payer or the virtual payee). As shown in FIG. 17, the method in which only detection or recognition is performed may be carried out by a sensor of the payee or a sensor included in the ITS-S including the payee, or may be carried out through a V2X message that the payer and/or the virtual payee periodically broadcasts or transmits. In addition, in the recognition or detection method, the existence of an approaching payer or virtual payee may be recognized, but the nearby payer or virtual payee may not be clearly identified. In this case, the payee may deliver or transmit a signal or message to the nearby or approaching payer or virtual payee in a broadcast manner rather than a unicast manner.

Referring to FIG. 17, in the method in which detection and identification is performed, the payee recognizes the approach of a payer, a virtual payee, or an ITS-S (or vehicle) including at least one of the same, the approaching payer, virtual payee, or ITS-S including at least one of the same may be identified. In the method in which detection and identification are performed, the detection and identification may be performed through a V2X message (e.g., CAM, BSM, etc.) periodically broadcast by the payer, the virtual payee, or the ITS-S including at least one of the same. Thereafter, the payee may communicate with the identified devices in a broadcast or unicast manner. In the method in which the detection and identification are performed, the detection and identification may be performed simultaneously or the identification may be sequentially performed after the detection.

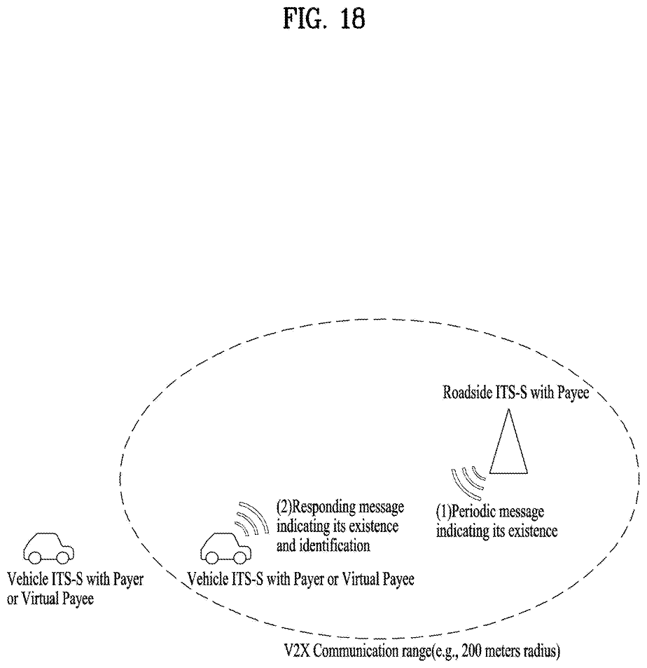

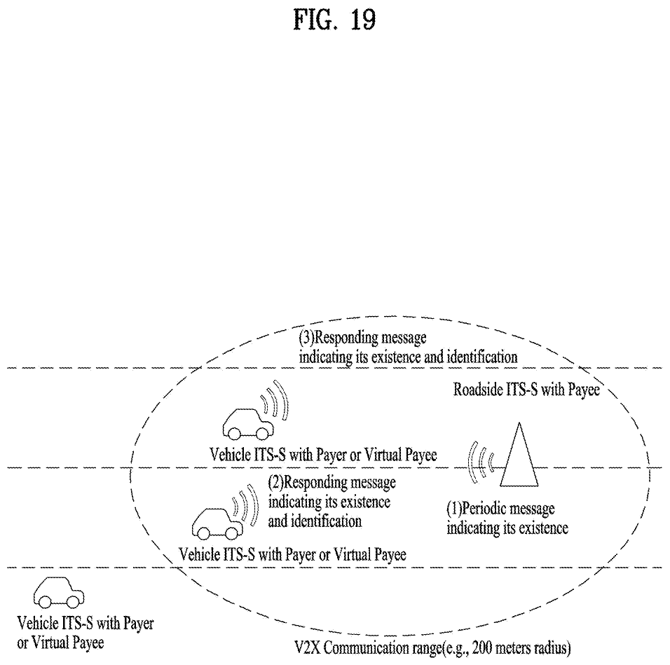

FIGS. 18 and 19 are diagrams illustrating a method for recognizing or detecting a target to perform V2X-based electronic payment.

Referring to FIG. 18, the payee may use V2X technology instead of detection-based technology (e.g., sensor, camera, etc.) to recognize (merely sense or both sense and identify) a target to perform electronic payment. In this case, the payee may quickly sense a vehicle (or ITS-S) including an approaching payer or virtual payee because using V2X technology has a wider communication coverage than using a sensor or camera. The payee may easily sense the vehicle (or ITS-S) including the payer or virtual payee that moves at a high speed. In this case, in the electronic payment method, electronic payment with the vehicle (or ITS-S) including the payer or the virtual payee may be performed through a more relaxed speed limit.

The roadside ITS-S including the payee may periodically transmit a V2X-related message (or an indication message) including information about the existence thereof. The payer or the virtual payee may receive the indication message from the payee or the ITS-S including the payee, and transmit a V2X message including the existence thereof and identification information in response to the received indication message. That is, the vehicle (or ITS-S) including the payer or the virtual payee may not transmit a V2X message including the existence thereof and identification information in an area not adjacent to the payee. By performing the initial procedure of electronic payment through such a V2X message, the speed limit of the vehicle in the electronic payment system may be relaxed.

Referring to FIG. 19, regarding the road collection system, the above-described V2X-based electronic payment method does not require attachment of a payee for all lanes, and payment with the vehicle including payers for all adjacent lanes may be performed through one payee.

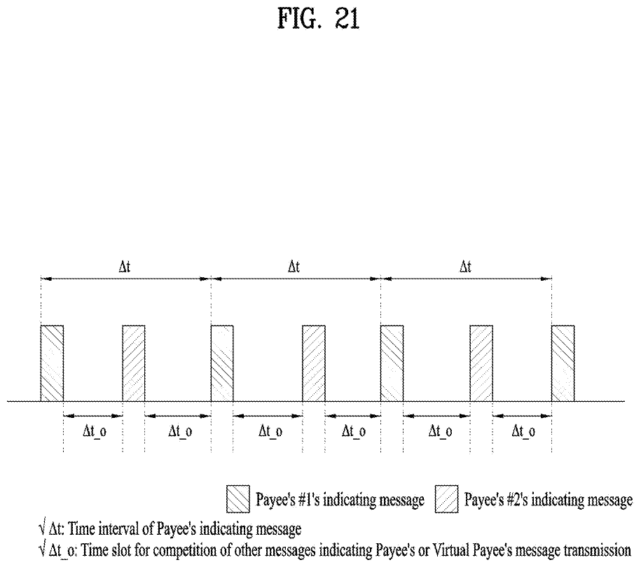

FIGS. 20 and 21 are diagrams illustrating a period and time resources in which the payee transmits an indication message.

According to the method described with reference to FIG. 19, a large number of payers or virtual payees may be located within the V2X communication coverage of one payee. In this case, a collision is highly likely to occur between messages (or packets) or signals transmitted by the payers or virtual payees.

Since the payee periodically transmits an indication message indicating the existence thereof, a time slot in which the message containing information on the existence and/or identification of a payee party or a virtual payee is transmitted may be assigned differently from a time slot in which the message indicating the payee is transmitted. In this case, the risk of collision between the message of the payee and the message of the payee party or virtual payee may be reduced.

Specifically, the payee needs to pre-inform the payer or the virtual payee of the frequency and/or interval of transmission (i.e., information on the allocated time slot) of the message. The payee may include information on the transmission frequency or transmission interval of the indication message in the indication message indicating the existence thereof, or may predetermine the information on the transmission frequency or transmission interval of the indication message before entering the billing area (i.e., coverage area) of the payee. In this case, the payer or the virtual payee may transmit the identification or response message thereof in the remaining time slots except for the time slot included in the indication message.

For example, referring to FIG. 20, the payee may transmit, to the payer or the virtual payee, information on At, which is a transmission interval during which the indication message is transmitted, and information on a time slot in which the indication message is transmitted (or a time slot in which the indication message is not transmitted, or a packet duration of the indication message). The payer or the virtual payee may determine the time slot in which the indication message is not transmitted (Δt_o=Δt−packet duration of the indication message) based on the information contained in the indication message.

Also, referring to FIG. 21, two or more payees may be located in a preconfigured area. In this case, a time slot in which an indication message is transmitted needs to be determined differently between the two or more payees. That is, a time slot for transmitting an indication message may be configured differently between the two or more payees. In this case, the payees may transmit an indication message containing information on two or more of the number n of payees in the preconfigured area, the duration of the indication message, and the transmission frequency (or transmission interval Δt) of the indication message. In this case, the payer or virtual payee may calculate or determine, based on the indication message, a time slot in which the two or payees do not transmit the indication message (Δt_o=Δt/n−packet duration of the message indicated by the payee party).

Next, types of a plurality of invoices related to payment between the payee, payer, and virtual payee sensed or recognized by each other may be defined.

Invoice A may be a predetermined type in which a financial value amount (e.g., fee, cost, price, etc.) for payment is predetermined. Invoice B may be a type in which price information varies depending on the selected item. Invoice C may be a type in which price information varies depending on the type of a payer or virtual payee, which is a payment subject. invoice D may be a type in which price information varies depending on the selected item and the type of the payer (or virtual payee).

For example, invoice A is a type of invoice in which the same amount is charged between payers. Invoice B is a type in which the payer may be charged a different amount of money depending on the item to be purchased. A typical example may be an invoice type suitable for drive-thru. Invoice C may be an invoice in which the amount varies depending on the type of a vehicle including the payer or the distance the vehicle moves. Invoice D may be an invoice type mixing invoices B and C.

A method of specifying an electronic payment target may vary depending on the invoice type. As described above, the electronic payment target may be specified by detection of the payer only, or may be specified by detection and identification. In addition, there may be cases where even detection of the electronic payment target is unnecessary.

Referring to Table 7 below, invoices C and D may be of invoice types that require an electronic payment object to be specified through detection and identification of a payer or a virtual payee. Invoice B may be of an invoice type requiring an electronic payment target to be specified through detection. In contrast, for invoice A, even specifying the electronic payment target is unnecessary. In other words, invoice A may be an invoice that may be issued without detection and identification, invoice B may be an invoice that is issued after specifying a payer or virtual payee upon detection thereof, and invoices C and D may be invoices that may be issued after specifying a payer or virtual payee upon detection and identification thereof

TABLE 7

| | No | “Detecting | “Detecting and |
|---|---|---|---|
| | “Recognizing” | only” | Identifying” |
| Invoice type #A | Allowed. | Allowed | Allowed |
| Invoice type #B | Not allowed | Allowed | Allowed |
| Invoice type #C & #D | Not allowed | Not allowed | Should be |
| | | | supported |

The payee and/or the payment server may need selected item information corresponding to a purchase target and/or identification information for identifying the payer transmitted from the payer to determine the payment amount in invoice B, C or D. Such information may be provided in the recognition step. When the payee is to determine the payment amount, the payee may determine the payment amount based on the selected item information corresponding to the purchase target requested by the payer and/or the identification information related to the payer. Alternatively, when the payment server is to determine the payment amount, the payee may provide the payment server with information necessary for determining the payment amount. For example, the payee may provide the payment server with the selected item information corresponding to the payment target, the identification information related to the payer, and a location of the payer or a value predefined between the payee and the payment server.

The exchange of the above-described information for determining the payment amount may be performed between the recognition step and the payment execution step. For example, the payee may identify the payer and determine the payment amount immediately after the recognition step. Alternatively, the payment server may determine the payment amount and identify the payer based on the selected item information and identification information for determination of the payment amount provided by the payee.

Hereinafter, a procedure in which the payer provides selected item information, which is selection information about a purchase target, to the payee will be described.

In the case of invoices B and D described above, the payer may need to perform a step (item selection step) of selecting a purchase target and/or transmitting selected item information that is information on the selected purchase target. The item selection step may be performed based on the V2X message. The electronic payment system including the item selection step that is based on the V2X message may provide a uniform or equal user experience to all users who make payments through all payers, and may provide an efficient payment system to users who are unfamiliar or uncomfortable with the existing drive-through ordering.

Table 8 shows definitions related to information about purchasable objects or items.

TABLE 8

| | |
|---|---|
| Descriptive Name | PurchasableItems |
| Identifier | DataType_xxx |
| ASN.1 | PurchasableItems ::= SEQUENCE |
| representation | {kindofPurchasableItems KindofPurchasableItems, |
| | itemDescription ItemDescription, |
| | itemPrice ItemPrice, |
| | . . .} |
| Definition | This DF identifies the purchasable items and their |
| | descriptions. |
| Unit | N/A |
| Descriptive Name | KindofPurchasableItems |
| Identifier | DataType_xxx |
| ASN.1 | KindofPurchasableItems ::= INTEGER (0 . . . |
| representation | 65535) |
| Definition | This DE identifies the number of kinds of |
| | purchasable items. |
| Unit | N/A |
| Descriptive Name | ItemDescription |
| Identifier | DataType_xxx |
| ASN.1 | ItemDescription ::= IA5String |
| representation | (size(kindofPurchasableItems)) |
| Definition | This DE provides descriptions for individual |
| | purchasable items. |
| Unit | N/A |
| Descriptive Name | ItemPrice |
| Identifier | DataType_xxx |
| ASN.1 | ItemPrice ::= INTEGER (0 . . . 65535) or |
| representation | INTEGER (0 . . . 16777215) |
| Definition | This DE (Data Element) identifies the prices |
| | for individual purchasable items. |
| Unit | Cent (cent of the regional currency unit. E.g., |
| | cent of US dollar in US, cent of EURO in the member |
| | countries of EU, etc.) |

Table 9 shows an example of the data element definition of items to select the V2X message.

TABLE 9

| | |
|---|---|
| Descriptive Name | ChosenItems |
| Identifier | DataType_xxx |
| ASN.1 | ChosenItems ::= ENUMERATED |
| representation | {kindofChosenItems KIndofChosenItems, |
| | chosenItems ChosenItems, |
| | numberofItems NumberofItems, |
| | . . .} |
| Definition | This DF identifies the chosen items to purchase and |
| | their number. |
| | kindofChosenItems should equal to or less than |
| | kindofPurchasableItems. |
| | The numeric values of chosenItems means the order of |
| | itemDescription. I.e., the “2” of chosenItems means |
| | the second item described by the itemDescription. |
| Unit | N/A |
| Descriptive Name | KindofChosenItems |
| Identifier | DataType_xxx |
| ASN.1 | KindofChosenItems ::= INTEGER (0 . . . 65535) |
| representation | |
| Definition | This DE identifies the number of kinds of items to |
| | purchase. |
| Unit | N/A |
| Descriptive Name | ChosenItems |
| Identifier | DataType_xxx |
| ASN.1 | ChosenItems ::= NumbericString |
| representation | (SIZE(kindofChosenItems)) or |
| | ENUMERATE (SIZE(kindofChosenItems)) |
| Definition | This DE identifies the items to purchase. |
| Unit | N/A |
| Descriptive Name | NumberofItems |
| Identifier | DataType_xxx |
| ASN.1 | NumberofItems ::= INTEGER |
| representation | (SIZE(kindofChosenItems)) (0 . . . 65535) |
| Definition | This DE identifies the number of individual |
| | chosen items to purchase. |
| Unit | N/A |

Each payment system may proceed with a payment procedure based on a unique application program or a unique message type used for payment in the payment system. In addition, conventional ordering methods, such as oral ordering used in conventional drive-throughs, may also be applied.

Hereinafter, an invoice notification procedure will be described. Here, the invoice notification procedure may optional, and may be performed before the payment procedure or after the invoice preparation procedure.

In the invoice notification procedure, the payee may provide payment amount information about the payment amount to the payer or the virtual payee through a V2X message (e.g., a V2X message containing an invoice). In addition, the payment amount information may be provided to the user of the payer or the virtual payee.

When the recognition procedure is not required (invoice A), the invoice notification procedure may be performed periodically.

In the case of a recognition procedure requiring recognition of the payer according to the detection, the invoice notification procedure may be divided into a notification scheme 1-1 for invoice A and a notification scheme 1-2 for invoice B. In the notification scheme 1-1, the invoice may be periodically notified only when the payee detects the payer (or virtual payee). In the notification scheme 1-2, the invoice may be periodically notified when the payee detects the payer (or virtual payee) and acquires selected item information from the payer.

In the case of the recognition procedure requiring detection and identification of the payer or the virtual payee, the invoice notification procedure may be performed according to a notification scheme 2-1 for invoice A, a notification scheme 2-2 for invoice B, and a notification scheme 2-3 for invoice C.

In the notification scheme 2-1, the invoice notification may be broadcast or unicast only when the payee party detects the payer, the virtual payee, or an ITS-S (or vehicle) including the same. In the notification scheme 2-2 and the notification scheme 2-3, the invoice notification may be broadcast or unicast when the payer, the virtual payee, or the ITS-S including the same is detected and selected item information is received therefrom.

Table 10 shows an example of data elements related to the invoice notification procedure.

TABLE 10

| | |
|---|---|
| Descriptive | Invoice |
| Name | |
| Identifier | DataType_xxx |
| ASN.1 | Invoice ::= INTEGER (0 . . . 65535) or |
| representation | INTEGER (0 . . . 16777215) |
| Definition | This DE (Data Element) identifies the amount of |
| | financial value for a payment which is requested |
| | to pay. |
| Unit | Cent (cent of the regional currency unit. E.g., cent |
| | of US dollar in US, cent of EURO in the member |
| | countries of EU, etc.) |

Alternatively, the V2X-based electronic payment method may include a payment request procedure. Specifically, the payee may transmit payment request information related to a payment request to the payer or the virtual payee through a V2X message (e.g., a V2X message containing information related to the payment request).

When it is not necessary to perform the recognition procedure (or when the recognition procedure is not supported), the payee may periodically broadcast a V2X message containing payment request information for requesting payment. When it is necessary to perform the recognition procedure (or when the recognition procedure is supported), the payee may periodically transmit a payment request message requesting the payment only when the virtual payee or the ITS-S is detected (or specified). When it is necessary to perform the recognition procedure requiring the detection and identification, the payee may periodically transmit (unicast or broadcast) a V2X message containing payment request information for requesting the payment only when the virtual payee or the ITS-S is detected and identified.

Table 11 shows an example defining data elements of the payment request information contained in the V2X message.

TABLE 11

| | |
|---|---|
| Descriptive | PaymentRequest |
| Name | |
| Identifier | DataType_xxx |
| ASN.1 | PaymentRequest ::= BOOLEAN |
| representation | |
| Definition | This DE (Data Element) indicates whether or not a |
| | payment is requested. |
| | “1” means that a payment is requested. |
| | “0” means that a payment is not request. |
| Unit | N/A |

When receiving the V2X message or signal containing the payment request information from the payee, the virtual payee may indicate or provide the payment request information and corresponding information to the user or driver of the payer located in the vehicle or ITS-S in which the virtual payee is included.

The V2X-based electronic payment method may also include a payment method informing procedure. In the payment method informing procedure, when the payer receives a payment request message containing payment request information for requesting payment from the payee, the payer may transmit a message containing payment method information related to the payment method to the payee. For example, when the payment method information is related to a credit card, the payment method information may include a credit card number, a holder's name, an expiration date, and a card confirmation value and code. In the payment method informing procedure, the ITS-S or user's permission related to the payer may be separately requested. Either automatic acceptance or automatic rejection may be preconfigured in relation to the user's permission, and the payer may respond according to the user's preconfigured permission.

Table 12 shows an example of a data frame or element related to payment method information contained in the V2X message.

TABLE 12

| | |
|---|---|
| Descriptive | PaymentMethod |
| Name | |
| Identifier | DataType_xxx |
| ASN.1 | PaymentMethod ::= SEQUENCE |
| representation | {cardNumber CardNumber, |
| | nameCardHolder NameCardHolder, |
| | expirationDate ExpirationDate, |
| | cardVerficationValue CardVerificationValue, |
| | . . .} |
| Definition | This DF (Data Frame) indicates information of a payment |
| | method to be used for the requested payment. |
| Unit | N/A |
| Descriptive | CardNumber |
| Name | |
| Identifier | DataType_xxx |
| ASN.1 | CardNumber ::= Numeric String (SIZE(16)) |
| representation | |
| Definition | This DE (Data Element) indicates the credit card number. |
| Unit | N/A |
| Descriptive | NameCardHolder |
| Name | |
| Identifier | DataType_xxx |
| ASN.1 | NameCardHolder ::= IA5String (SIZE(1 . . . 24)) |
| representation | |
| Definition | This DE (Data Element) indicates the name of credit card |
| | holder. |
| Unit | N/A |
| Descriptive | ExpirationDate |
| Name | |
| Identifier | DataType_xxx |
| ASN.1 | ExpirationDate ::= NumericString (SIZE(8)) |
| representation | |
| Definition | This DE (Data Element) indicates the expiration date of |
| | the credit card, e.g., 2 digits for month, 2 digits for |
| | date, and 4 digits for year sequentially. |
| Unit | N/A |
| Descriptive | CardVerificationValue |
| Name | |
| Identifier | DataType_xxx |
| ASN.1 | CardVerificationValue::= NumericString |
| representation | (SIZE(1 . . . 10)) |
| Definition | This DE (Data Element) indicates the verification value |
| | for the credit card. |
| Unit | N/A |

In the above-described electronic payment method, a secure electronic payment may be performed through hybrid communication. When the payer or the user (or driver) of the payer receives the payment request message from the virtual payee, the payment method information related to the payment method may be transmitted to the virtual payee. Here, the exchange of the above-described information between the payer and the virtual payee may be performed using a very short-range technology such as a magnetic stripe, an IC chip, NFC, a barcode, an RFID tag, or the like. In this case, unlike in V2X communication, the above-mentioned information related to the payment method is exchanged only in a short distance, and accordingly the payer and the virtual payee may safely exchange the information related to the payment method without a risk of leakage of the information related to the payment method to the outside.

As described above, the payment method information may generally include information necessary for performing payment, and the provision of the payment method information may be automatically accepted or automatically rejected according to the setting of the payer.

Alternatively, the V2X-based electronic payment method may further include the step of submitting the payment method information. The payee may transmit the payment method information received from the payer to the payment server, such that payment may be performed according to the payment method information. The payment method information transmitted from the payer may be delivered through a V2X message between the payer and the payee. The payee may also deliver payee information related to the payee to the payment server. The payee information may include various types of information such as a payment amount, identification information related to the payee, and location information about the payee. Communication between the payee and the payment server may be performed over a secure network or a secure cellular network.

Alternatively, the step of submitting the payment method information may be performed through the virtual payee. Specifically, the virtual payee may deliver the information related to the payment method received from the payer, information about the payee, and information related to the virtual payee to the payment server to perform payment. Here, the information related to the virtual payee may include identification information and location information about the virtual payee.

Alternatively, the V2X-based electronic payment method may include a payment execution procedure. The payment execution procedure may be performed by the payment server based on information related to the payment method provided by the payer.

Alternatively, the V2X-based electronic payment method may include a payment confirmation procedure. In the payment confirmation procedure, the payee may transmit the payment confirmation information received from the payment server to the payer. The payment confirmation information may include information of “approved”, “rejected” or “error occurred”. In case of “rejected” and “error occurred”, detailed reasons may be sent sequentially to the payee and the payer. Also, the payment confirmation information may include information on a payment amount for which payment is completed based on the information related to the payment method.

Alternatively, the payment confirmation procedure may be performed through the virtual payee. The payment confirmation information may be delivered from the payment server to the virtual payee via the payee. The virtual payee may provide the transferred payment confirmation information to the corresponding payer. The payment confirmation information may include information of “approved”, “rejected” or “error occurred”. In case of “rejected” and “error occurred”, detailed reasons may be sequentially delivered to the payee, the virtual payee, and the payer in this order. Also, the payment confirmation information may include information on a payment amount for which payment is completed based on the information related to the payment method.

Table 13 shows an example of a data frame and elements of the V2X message containing the payment confirmation information.

TABLE 13

| | |
|---|---|
| Descriptive | PaymentResult |
| Name | |
| Identifier | DataType_xxx |
| ASN.1 | PaymentResult::= SEQUENCE |
| representation | {codePaymentResult CodePaymentResult, |
| | subCodePaymentResult SubCodePaymentResult, |
| | . . .} |
| Definition | This DF (Data Frame) indicates the result of |
| | performed payment. |
| Unit | N/A |
| Descriptive | CodePaymentResult |
| Name | |
| Identifier | DataType_xxx |
| ASN.1 | CodePaymentResult ::= INTEGER |
| representation | {approved (1), rejected (2), error (3), . . .} |
| | (0 . . . 255)} |
| Definition | This DE (Data Element) indicates the high level |
| | result of performed payment. |
| Unit | N/A |
| Descriptive | SubCodePaymentResult |
| Name | |
| Identifier | DataType_xxx |
| ASN.1 | SubCodePaymentResult ::= INTEGER |
| representation | {cardNumberMismatch (1), |
| | cardHolderNameMismatch(2), |
| | expirationDateMistmatch (3), |
| | verificationValueMistmatch (4), |
| | expiredCard (5), exceedLimitofPaymentAmount |
| | (6), . . .} (0 . . . 255)} |
| Definition | This DE (Data Element) indicates the low level result |
| | of performed payment. |
| Unit | N/A |

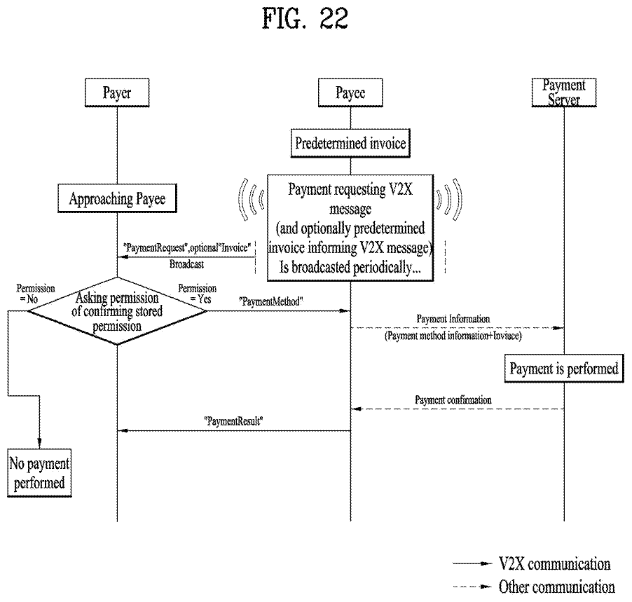

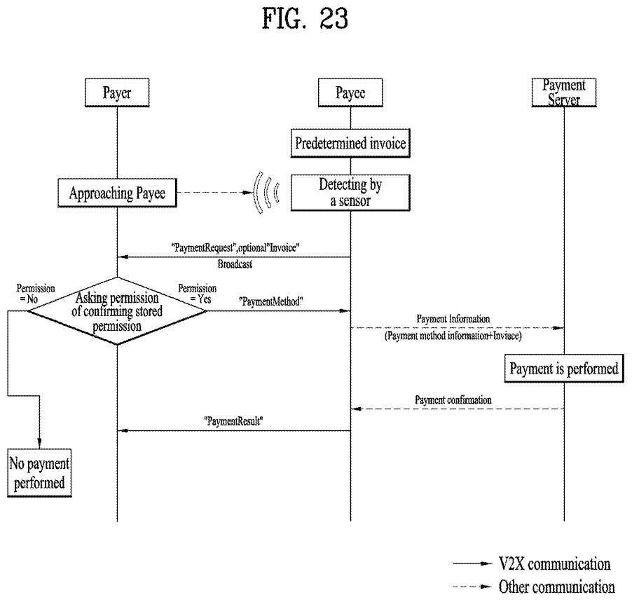

FIGS. 22 and 23 are diagrams illustrating an electronic payment method for invoice A.

Referring to FIG. 22, the payer may receive or detect a payment request message containing predetermined invoice information periodically transmitted from the payee. The payer may determine whether to provide payment method information to the payee based on a user input for the payment request message. Alternatively, the payer may determine whether to provide the payment method information to the payee based on automatic approval information preconfigured in relation to the payment request message. Here, the preconfigured automatic approval information is information preconfigured as to whether the user of the payer automatically will automatically approve or reject provision of the payment method information.

When the provision of the payment method information is accepted in response to the payment request message, the payer may provide the payment method information to the payee. The payee may provide the provided payment method information and/or payment related invoice information to the payment server and receive a payment confirmation message containing information on payment confirmation. The payee may transmit a message containing information on a payment result to the payer based on the received payment confirmation message. When the provision of the payment method information is rejected in response to the payment request message, the payer may not provide the payment method information to the payee.

Referring to FIG. 23, when the payer approaches the payee within a predetermined distance, the payer may receive a payment request message from the payee. The payment request message may contain a predetermined invoice (including information about the same amount for all payers), and may be periodically transmitted by the payee. For example, the payment request message may be periodically broadcast by the payee for a predetermined period of time from the time when the approach of the payer is detected.

Upon receiving the payment request message, the payer may determine whether to provide payment method information to the payee based on a user input corresponding to the payment request message. Alternatively, the payer may determine whether to provide the payment method information to the payee based on automatic approval information preconfigured in relation to the payment request message. Here, the preconfigured automatic approval information is information preconfigured as to whether the user of the payer will automatically approve or automatically reject the provision of the payment method information.

When the provision of the payment method information is accepted in response to the payment request message, the payer may provide the payment method information to the payee. The payee may provide the provided payment method information and/or payment related invoice information to the payment server and receive a payment confirmation message containing information on payment confirmation. The payee may transmit a message containing information on a payment result to the payer based on the received payment confirmation message. When the provision of the payment method information is rejected in response to the payment request message, the payer may not provide the payment method information to the payee.

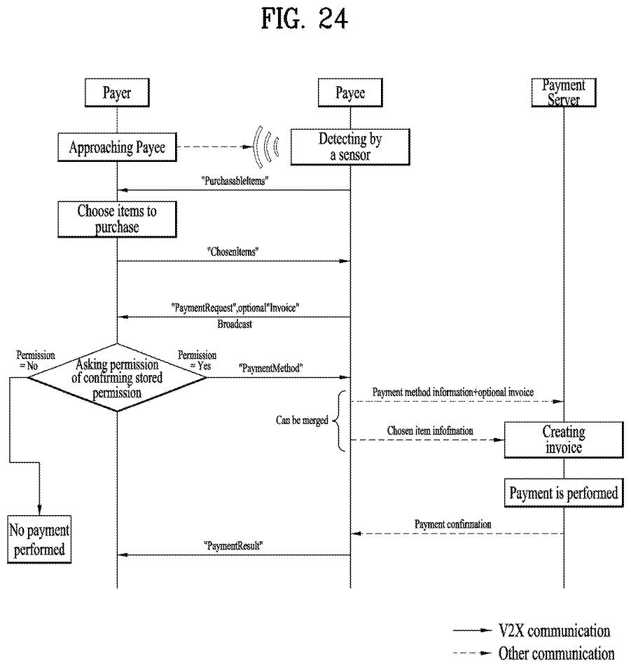

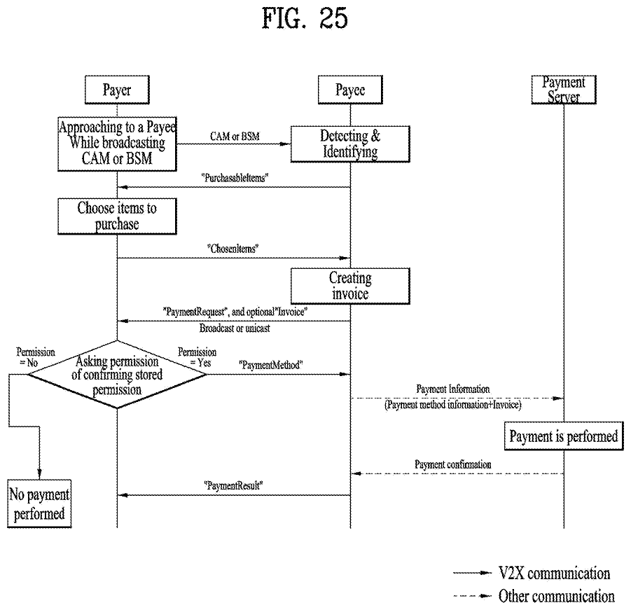

FIGS. 24 and 25 are diagrams illustrating an electronic payment method based on invoice B.

When the payer approaches the payer within a predetermined distance, the payer may receive a message containing information on a plurality of selectable items from the payee. The message containing information on the plurality of selectable items may be periodically broadcast by the payee for a predetermined period of time from the time when the approach of the payer is detected.

Here, referring to FIG. 24, the recognition procedure may be performed based on whether the payer is detected by a sensor or camera of the payee. Alternatively, referring to FIG. 25, the recognition procedure may be performed based on whether the payee receives a V2X message (CAM, BSM) periodically transmitted by the payer.

The payer may select at least one item based on the plurality of items, and may provide a message containing selected item information on the at least one selected item to the payee. The payer may receive a payment request message, which is a response to the selected item information, from the payee.

Upon receiving the payment request message, the payer may determine whether to provide payment method information to the payee based on a user input corresponding to the payment request message. Alternatively, the payer may determine whether to provide payment method information to the payee based on preconfigured automatic approval information. Here, the preconfigured automatic approval information is information preconfigured as to whether the user of the payer will automatically approve or automatically reject the provision of the payment method information.

When the provision of the payment method information is accepted in response to the payment request message, the payer may provide the payment method information to the payee. The payee may provide the provided payment method information, the selection information, and/or payment related invoice information to the payment server and receive a payment confirmation message containing information on payment confirmation. The payee may transmit a message containing information on a payment result to the payer based on the received payment confirmation message. When the provision of payment method information is rejected in response to the payment request message, the payer may not provide the payment method information to the payee.

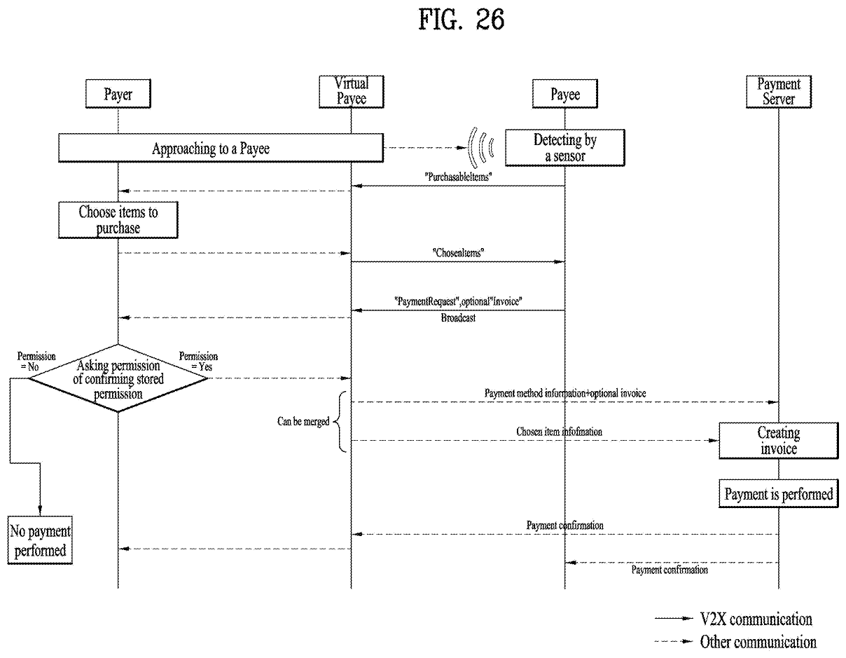

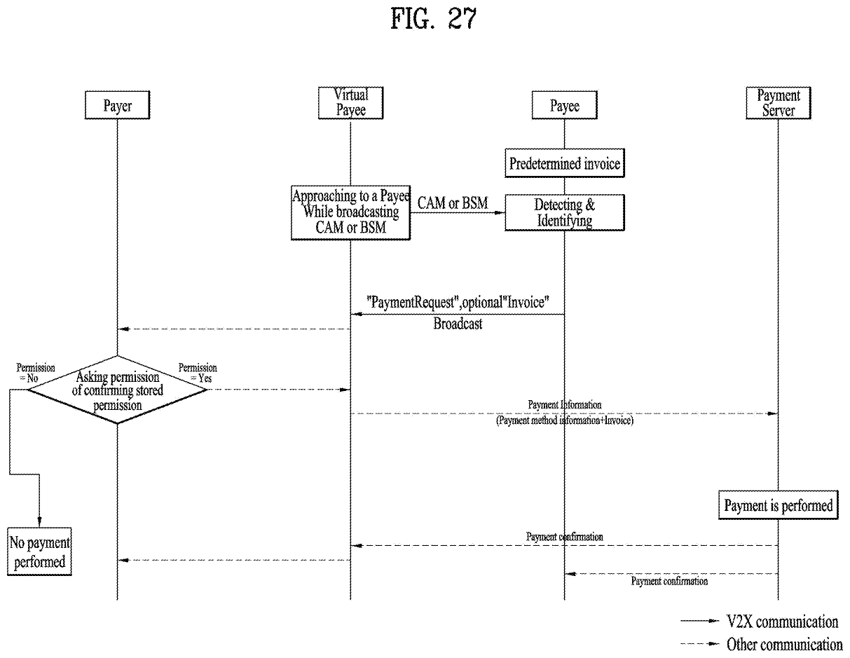

FIGS. 26 and 27 are diagrams illustrating a method for a virtual payee to perform an electronic payment based on V2X communication.

Referring to FIG. 26, the virtual payee may receive selectable item information from the payee. The virtual payee may provide the item information to a payer included in a vehicle or ITS-S corresponding thereto, and may receive selection information about a selected item list from the payer. The virtual payee may deliver or transmit the selection information to the payee through a V2X message. The virtual payee may receive, from the payee, a payment request message that is a response to the V2X message containing the selection information.

The virtual payee may provide or transmit the payment request message to the payer. The virtual payee may receive payment method information from the payer. The virtual payee may transmit a message containing the payment method information and the selection information to the payment server. The virtual payee may receive information about a payment result according to the payment from the payment server, and may provide the received information to the payer. The payment method information may be transmitted/received between the payer and the virtual payee by a separate short-range communication link rather than a V2X message.

Alternatively, the virtual payee may not receive a message related to the payment method information from the payer. In this case, if the message related to the payment method information is not provided for a preset period of time, the virtual payee may presume that the payer has rejected the payment according to the payment request message. The payment method information may be transmitted from the payer to the virtual payee according to an input from the user of the payer or automatic acceptance by the user.

Alternatively, referring to FIG. 27, the virtual payee may periodically transmit or broadcast a V2X message such as CAM or BSM. The virtual payee may receive a payment request message or a message containing item information from an approaching payee by periodically transmitting the V2X message. In other words, the payee may transmit or broadcast a payment request message or item information to the virtual payee when the V2X message periodically transmitted by the virtual payee is detected.

The virtual payee may receive the payment method information from the payer by providing the payment request message to the payer. Alternatively, the virtual payee may provide or transmit the item information to the payer, and receive or be provided with selection information from the payer. In this case, the virtual payee may provide the selected item information to the payee, and then may provide the payment request message transmitted by the payee to the payer.

The virtual payee may provide or transmit the payment request message to the payer. The virtual payee may receive payment method information from the payer. The virtual payee may transmit a message containing the payment method information and the selection information to the payment server. The virtual payee may receive information about a payment result according to the payment from the payment server, and may provide the received information to the payer.

Hereinafter, for simplicity, the payee is defined as an RSU, the virtual payee is defined as a first device, and the payer is defined as a second device.

The first device may perform a sidelink or V2X based electronic payment. The first device may be included in the vehicle, and may be a device or component of the vehicle. The second device may be included in the same vehicle as the first device, and the RSU may be an external device.

The first device may periodically transmit a sidelink or V2X signal of at least one of the CAM, DENM, or BSM. The first device may inform the RSU of its approach according to the transmission of the V2X signal or sidelink signal, and receive a sidelink signal or V2X signal containing a payment request message, an indication message, or an item information message as a response signal. When the recognition procedure is not needed (or in the case of invoice A), the first device may receive, from the RSU, a sidelink signal or V2X signal containing a payment request message, an indication message, or an item information message, regardless of periodic transmission of the sidelink or V2X signal of at least one of the CAM, DENM, or BSM.

The RSU may periodically transmit the indication message containing payment-related information or the above-described payment request message based on the invoice type. Specifically, the RSU may transmit the indication message, the item information message, or the payment request message without performing a recognition procedure for the first device or the second device (or without considering whether the first device or the second device is recognized or identified). Alternatively, the RSU may need to perform the recognition procedure for the first device or the second device. That is, the RSU may need to recognize the approach of the first device through a sensor or the sidelink or V2X signal of at least one of the CAM, DENM, or BSM of the first device. In this case, the RSU may transmit the indication message, the item information message, or the payment request message when the sidelink or V2X signal of at least one of the CAM, DENM, and BSM of the first device is detected.

Alternatively, the first device may receive an indication message from the RSU while periodically transmitting a sidelink or V2X signal of at least one of the CAM, DENM, and BSM. The indication message may include allocation information on time resources in which the RSU periodically transmits the payment request message, the indication message, or the like. Specifically, the allocation information may include time resource information and transmission periodicity information about transmission of the message of the RSU, or may include the number of a plurality of adjacent RSUs and slot resource information about each of the plurality of RSUs. The first device may determine a transmission timing of a response signal or message to the RSU based on the allocation information. Here, the response signal or message may include a message containing identification information or a selected item message as described above.

Alternatively, the first device may determine the transmission timing of the response signal or message by additionally considering the PTRS or PRS included in the indication message. The PTRS or PRS is a reference signal for indirectly indicating distance information between the first device and the RSU according to the phase shift information. That is, the first device may estimate the distance to the RSU by calculating the phase shift information based on the PTRS or PRS included in the indication message. The first device may determine which time resource to use among the remaining time resources excluding the allocation information according to the estimated distance. For example, when the first to fourth slots are available according to the allocation information, the first device may use any one of the first to fourth slots based on the distance estimated through the PTRS or the PRS. For example, slots in an order corresponding to a quotient acquired by dividing the estimated distance by the number of available slots (e.g., within one transmission period) based on the allocation information may be used. In this case, collisions between response signals may be minimized by distributing transmission timings according to the estimated distance between payers or virtual payees. Alternatively, the first device may determine a transmission time resource for the response signal based on the phase shift value of the PTRS or PRS rather than the estimated distance.

Alternatively, when the distance estimated based on the PTRS or the PRS included in the indication message is greater than or equal to a preset threshold distance, the first device may determine a transmission timing of the response message or signal in the next transmission period based on the allocation information. This is intended to allow a device close to the RSU to perform exchange of electronic payment information first.

The first device may deliver or transmit the message or information received from the RSU to the second device based on the invoice type. Specifically, the first device may receive a payment request message for a fixed amount from the RSU. In this case, the first device may determine that the invoice type is invoice A based on the payment request message, and transmit payment information on the payment amount and/or details included in the received payment request message to the second device.

Alternatively, the first device may receive an item information message containing information on selectable items from the RSU, and may identify the invoice type as invoice B based on the item information message. In this case, the first device may transmit or deliver payment information including an item list and price corresponding to invoice B to the second device. Next, the first device may receive selected item information on a selected item from the second device. The first device may transmit a sidelink signal or V2X signal containing the selected item information to the RSU. The first device may receive a payment request message containing information on a payment amount according to the selected item information, and may deliver payment information including the selected item and the payment amount to the second device.

Alternatively, the first device may receive an item information message containing information related to a movement distance from the RSU, and may identify the invoice type as invoice C based on the item information message. In this case, the first device may transmit its identification information to the RSU through a V2X signal or a sidelink signal. The first device may receive a payment request message containing price information corresponding to its movement distance and vehicle type from the RSU, and may provide the second device with payment information including a payment amount according to the determined distance information and vehicle type. That is, in the case of invoice type C, the first device may receive the payment request message from the RSU according to the transmission of the identification information.

When the first device transmits payment information for the second device, the second device may determine whether to provide payment method information according to the payment information. Whether to provide the payment method information may be determined based on a user input of the second device or preconfigured automatic acceptance information. When the acceptance procedure is performed by the second device, the first device may be provided with or receive payment method information from the second device. Here, the payment method information may be personal information and needs to be prevented from being leaked to the outside as much as possible. That is, when the payment method information is transmitted through a V2X signal or a sidelink signal, there is a risk that even an external vehicle or an external device may receive the signal for the payment method information. In consideration of this issue, the first device and the second device may transmit/receive the payment method information through a first communication link configured separately from the sidelink.

Specifically, the first communication link may be a link created by a short-range communication technology of at least one of a magnetic stripe, an IC chip, near-field communication (NFC), a barcode, and a radio-frequency identification (RFID) tag. For example, the payment method information may be transferred or transmitted from the second device to the first device on a short-range communication link through NFC separately provided in the first device and the second device.

The first device may transmit the payment method information to the payment server. That is, the first device does not provide the payment method information to the RSU. Specifically, additional security processing needs to be performed to ensure that the payment method information is not leaked to the outside, and it may not be easy to perform the additional security processing on the transmission through the V2X link or sidelink to the RSU. Accordingly, the first device may directly provide the payment method information to the payment server through a dedicated network in which a communication network to which a dedicated security application and a dedicated security protocol is applicable is formed. Thereafter, the first device may receive payment result information on the result of the electronic payment from the payment server over the dedicated network. That is, the RSU may provide only payment-related information to the first device, and the payment procedure may be performed between the first device and the payment server.

Such a V2X-based electronic payment system may be efficiently applied to a situation in which a driver driving a vehicle has to pay a toll or a required fee in a drive-thru situation. Specifically, the above-described V2X-based electronic payment system may minimize the inconvenience causing the driver to stop the vehicle and get off the vehicle to perform electronic payment, thereby maximizing the driver's convenience and traffic efficiency. In addition, by introducing a virtual payee, the V2X-based electronic payment system may perform an information provision procedure related to a payment method, which has a high risk of personal information leakage during a payment procedure through V2X communication, through in-vehicle communication. That is, useful information necessary for payment may be provided to the driver through the virtual payee by the V2X communication, but payment method information, which is sensitive to leakage, may be provided over a separately configured short-range network to guide safe electronic payment.

Communication System Example to which the Present Invention is Applied

Although not limited thereto, various descriptions, functions, procedures, proposals, methods, and/or operational flow charts of the present invention disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

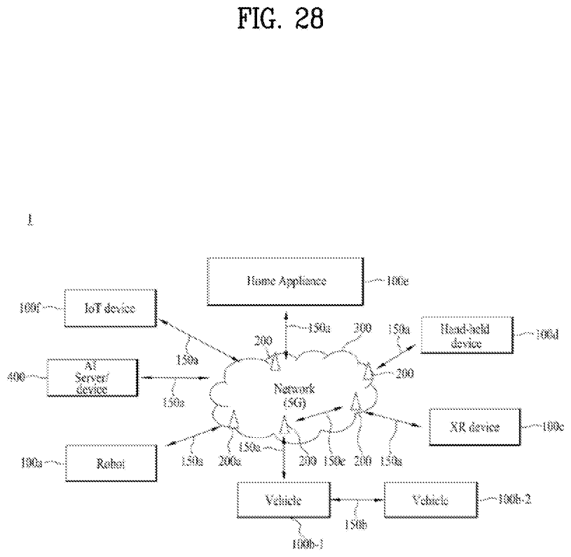

FIG. 28 illustrates a communication system applied to the present invention.

Referring to FIG. 28, a communication system 1 applied to the present invention includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present invention.

Examples of Wireless Devices to which the Present Invention is Applied

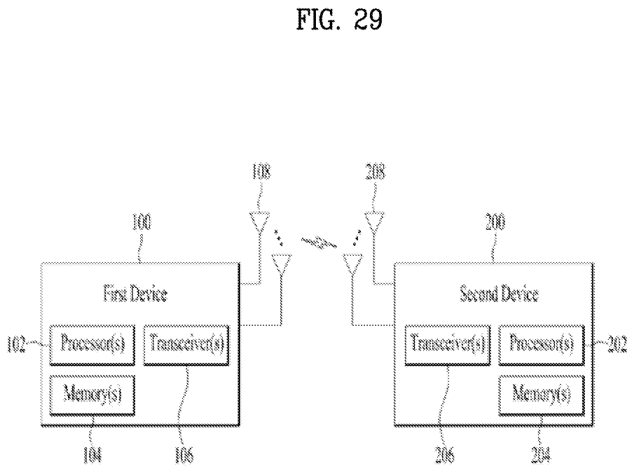

FIG. 29 illustrates a wireless device applicable to the present invention.

Referring to FIG. 29, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 28.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present invention, the wireless device may represent a communication modem/circuit/chip.

Specifically, the UE may include a processor 102 connected to the RF transceiver, and a memory 104. The memory 104 may include at least one program capable of performing operations related to the embodiments described with reference to FIGS. 15 to 27. The processor may control the RF transceiver to receive a first message containing information related to electronic payment from a roadside unit (RSU) through the sidelink, to transmit corresponding payment information to a second device based on an invoice type contained in the first message, and to receive payment method information from the second device through a first communication link, which is configured separately. The first communication link may be a communication link created based on short-range communication technology. The processor 102 may perform operations related to the embodiments described with reference to FIGS. 15 to 27 based on the program contained in the memory 104.

Alternatively, a chipset including the processor 102 and the memory 104 may be configured. In this case, the chipset may include at least one processor and at least one memory operatively connected to the at least one processor and, when executed, causing the at least one processor to perform an operation. The operation may include receiving a first message containing information related to electronic payment from a roadside unit (RSU) through the sidelink, transmitting corresponding payment information to a second device based on an invoice type contained in the first message, and receiving payment method information from the second device through a first communication link, which is configured separately. The first communication link may be a communication link created based on short-range communication technology. In addition, the processor 102 may perform operations related to the embodiments described with reference to FIGS. 15 to 27 based on the program included in the memory 104.

Alternatively, there may be provided a computer readable storage medium including at least one computer program causing the at least one processor to perform an operation. The operation may include receiving a first message containing information related to electronic payment from a roadside unit (RSU) through the sidelink, transmitting corresponding payment information to a second device based on an invoice type contained in the first message, and receiving payment method information from the second device through a first communication link, which is configured separately. The first communication link may be a communication link created based on short-range communication technology.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present invention, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Invention is Applied

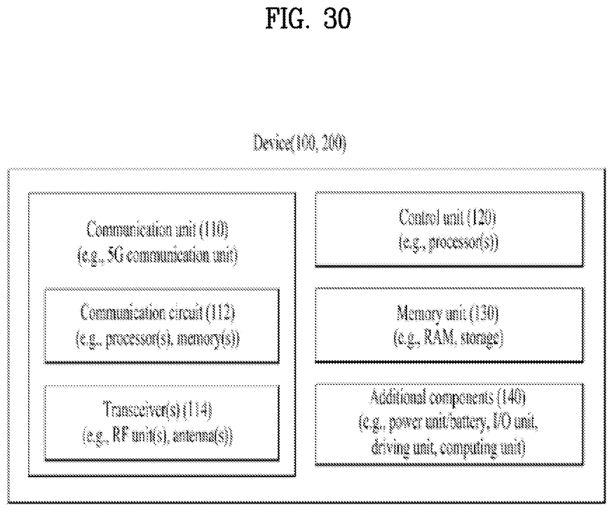

FIG. 30 illustrates another example of a wireless device applied to the present invention. The wireless device may be implemented in various forms according to a use-case/service (refer to FIG. 28)

Referring to FIG. 30, wireless devices 100 and 200 may correspond to the wireless devices 100 and 200 of FIG. 29 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 29. For example, the transceiver(s) 114 may include the one or more transceivers 106 and 206 and/or the one or more antennas 108 and 208 of FIG. 29. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 28), the vehicles (100b-1 and 100b-2 of FIG. 28), the XR device (100c of FIG. 28), the hand-held device (100d of FIG. 28), the home appliance (100e of FIG. 28), the IoT device (100f of FIG. 28), a digital broadcast terminal, a hologram device, a public safety device, an MTC device, a medicine device, a fintech device (or a finance device), a security device, a climate/environment device, the AI server/device (400 of FIG. 28), the BSs (200 of FIG. 28), a network node, etc. The wireless device may be used in a mobile or fixed place according to a use-example/service.

In FIG. 30, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 30 will be described in detail with reference to the drawings.

Examples of Mobile Devices to which the Present Invention is Applied

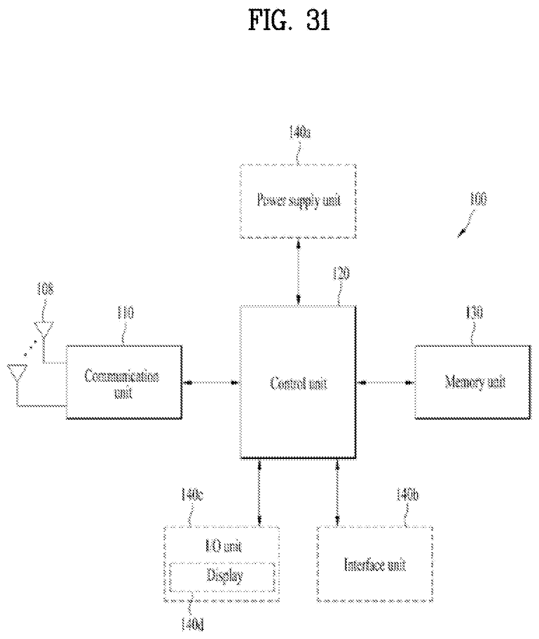

FIG. 31 illustrates a hand-held device applied to the present invention. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 31, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to140c correspond to the blocks 110 to 130/140 of FIG.30, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Examples of Vehicles or Autonomous Vehicles to which the Present Invention is Applied

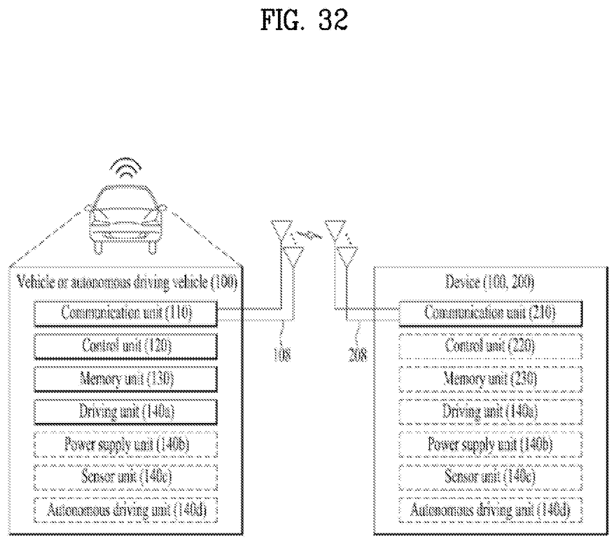

FIG. 32 illustrates a vehicle or an autonomous driving vehicle applied to the present invention. The vehicle or autonomous driving vehicle may be implemented by a mobile robot, a car, a train, a manned/unmanned Aerial Vehicle (AV), a ship, etc.

Referring to FIG. 32, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 30, respectively

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The embodiments described above are those in which components and features of the present invention are combined in a predetermined form. Each component or feature should be considered optional unless explicitly stated otherwise. Each component or feature may be implemented in a form that is not combined with other components or features. In addition, it is also possible to constitute an embodiment of the present invention by combining some components and/or features. The order of operations described in the embodiments of the present invention may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present invention have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The above-described embodiments of the present disclosure are applicable to various mobile communication systems.

What is claimed is:

1. A method for transmitting and receiving an electronic payment related signal by a first device in a wireless communication system supporting a sidelink, the method comprising:
receiving a first message containing information related to electronic payment from a roadside unit (RSU) through the sidelink;
transmitting corresponding payment information to a second device based on an invoice type included in the first message; and
receiving payment method information from the second device through a first communication link configured separately,
wherein the first communication link is a communication link created based on a short-range communication technology.

2. The method of claim 1, wherein the short-range communication technology is for short-range communication according to at least one of a magnetic stripe, an IC chip, near-field communication (NFC), a bar code, and a radio-frequency identification (RFID) tag.

3. The method of claim 1, wherein the invoice type includes a first type containing predetermined payment information, and a second type in which payment information is differently determined according to a response of the first device or a type of a vehicle including the first device.

4. The method of claim 3, wherein, when the invoice type is the second type, the first message is a response message to periodic transmission of at least one of a cooperative awareness message (CAM), a decentralized environmental notification message (DENM), or a basic safety message (BSM) of the first device.

5. The method of claim 4, further comprising:
when the invoice type is the second type, transmitting to the RSU a second message containing item information on an item necessary for determination of a payment amount,
wherein the payment information is acquired based on a payment request message, the payment request message being a response message to the second message.

6. The method of claim 5, wherein the first message further contains allocation information about time resources for transmission of a message of the RSU,
wherein a transmission timing of the second message is determined based on the allocation information.

7. The method of claim 5, wherein the allocation information includes the number of RSUs included in a preconfigured region, time resource allocation information about each of the RSUs, and information about a transmission period.

8. The method of claim 5, wherein a transmission timing of the second message is determined based on a degree of phase shift acquired based on a positioning reference signal (PRS) or a phase tracking reference signal (PTRS) included in the first message.

9. The method of claim 1, wherein, when the invoice type is a first type, the first message is periodically and repeatedly transmitted by the RSU regardless of whether the first device approaches.

10. The method of claim 1, further comprising:
transmitting the payment method information to a payment server; and
receiving information on a payment result from the payment server,
wherein the payment method information is transmitted according to a security protocol configured by the payment server.

11. The method of claim 1, wherein the first device is attached to the same ITS-S or vehicle as the second device.

12. A first device for transmitting and receiving a signal in a wireless communication system supporting a sidelink, the first device comprising:
a radio frequency (RF) transceiver; and
a processor connected to the RF transceiver,
wherein the processor controls the RF transceiver to:
receive a first message containing information related to electronic payment from a roadside unit (RSU) through the sidelink;
transmit corresponding payment information to a second device based on an invoice type included in the first message; and
receive payment method information from the second device through a first communication link configured separately,
wherein the first communication link is a communication link created based on a short-range communication technology.

13. The first device of claim 11, wherein the short-range communication technology is for short-range communication according to at least one of a magnetic stripe, an IC chip, near-field communication (NFC), a bar code, and a radio-frequency identification (RFID) tag.

14. A chipset for transmitting and receiving signals in a wireless communication system supporting a sidelink, the chipset comprising:
at least one processor; and
at least one memory operatively connected to the at least one processor and, when executed, causing the at least one processor to perform an operation,
wherein the operation comprises:
receiving a first message containing information related to electronic payment from a roadside unit (RSU) through the sidelink;
transmitting corresponding payment information to a second device based on an invoice type included in the first message; and
receiving payment method information from the second device through a first communication link configured separately,
wherein the first communication link is a communication link created based on a short-range communication technology.

15. The chipset of claim 14, wherein the processor controls a driving mode of a device connected to the chipset based on the invoice type.
